(19) United States
(12) Patent Application Publication
(10) Pub. No.: US 2005/0240437 A1
(43) Pub. Date: Oct. 27, 2005

(54) Information retrieval system and method thereof

(76) Inventor: Robert H. Cunningham, Virginia Beach, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/098,572

(22) Filed: Apr. 5, 2005

Related U.S. Application Data
(60) Provisional application No. 60/559,029, filed on Apr. 5, 2004.

(51) Int. Cl. G06F 17/60

(52) U.S. Cl. 705/2

(57) ABSTRACT

The information retrieval system, method and computer product of the present invention is an automated background process that requires no integration programming, manual mapping, or user intervention. In one embodiment, a task is initiated and communicated to at least one physician system having a text data collection. The task can be a query response or user defined. A predetermined template is selected from a plurality of templates which corresponds to the text data collection at the physician system. The plurality of templates are associated with dissimilar text data collections. Information is identified in the text data collection at the physician system. The information is extracted from the text data collection, and transmitted to the service provider system. In another embodiment, a system for identifying and extracting information from dissimilar text data collections is provided. The system includes a listener/transport interface for communicating with a service provider system, and a template interface for communicating with at least one physician system. An engine interface initiates tasks at the service provider system via the listener/transport interface, and communicates the tasks to the at least one physician system having a database via the template interface. Information is identified in and extracted from the database of the physician system, and transmitted to the service provider system.

### CROSS-REFERENCE TO RELATED APPLICATION

This application claims the benefit of the filing date of provisional application Ser. No. 60/559,029 filed on Apr. 5, 2004, which is incorporated by reference in its entirety.

### BACKGROUND OF THE INVENTION

1. Field of the Invention

The present invention relates, generally, to an information retrieval system, computer product and method thereof and, more particularly, to a system and method of identifying and extracting information from dissimilar systems and applications.

2. Description of the Background

Generally, when services (e.g., laboratory work) are performed on behalf of physicians, clinics or the like, the service provider is billed separately for its services. In order to receive compensation, the service provider must complete and submit a wide variety of papers and/or forms. Patient information (e.g., demographics, insurance, scheduling data, etc.) is provided to the service provider in hard-copy documents from the physicians, or electronically from physicians' dissimilar computer systems.

Patient information contained in the hard-copy documents is transferred to the service provider's wide variety of papers and/or forms. In some cases, the patient information contained in the documents can be incorrect, incomplete, illegible, etc. Accordingly, if a bill containing the incorrect information is presented to an insurance company or a patient for payment, the bill is rejected or returned to the service provider to be correctly completed.

A service provider that receives the patient information electronically from the physicians' dissimilar computer systems requires numerous computer products since each physician system is different. Further, the physician systems can be problematic-antiquated systems with no external interfaces, terminal based computers without any network interfaces, etc., or contain pre-SQL databases with outdated data structures. In such instances, conventional methods, such as screen scraping and report parsing, are used to collect and report the patient information. Screen scraping requires large amounts of programming and maintenance since it is difficult to build a single application for all possible system screen modifications. Report parsing generally relies on office personnel to be diligent in running reports and requires custom interfaces on a per practice basis. These methods, however, are time consuming, costly, antiquated and undesirable.

Accordingly, there remains a need for a system, computer product, and methodology for electronically identifying and extracting information from dissimilar systems and applications using a universal platform.

### SUMMARY OF THE INVENTION

In a first aspect of the present invention, a method of conducting an electronic retrieval of information is disclosed. A task is initiated and communicated to at least one physician system having a text data collection. The task can be a query response or user defined. A predetermined template is selected from a plurality of templates which corresponds to the text data collection at the physician system. The plurality of templates are associated with dissimilar text data collections. Information is identified in the text data collection at the physician system. The information is extracted from the text data collection, and transmitted to the service provider system.

In another aspect of the present invention, a system for identifying and extracting information from dissimilar text data collections is described. The system includes a listener/transport interface for communicating with a service provider system, and a template interface for communicating with at least one physician system. An engine interface initiates tasks at the service provider system via the listener/transport interface, and communicates the tasks to the at least one physician system having a database via the template interface. Information is identified in and extracted from the database of the physician system, and transmitted to the service provider system.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is functional block diagram of the application architecture according to an exemplary embodiment of the present invention;

FIG. 2A is a functional block diagram of the architecture for an information retrieval system according to an exemplary embodiment of the present invention;

FIG. 2B is a block diagram of the client-user device illustrated in FIG. 2A;

FIG. 2C is a block diagram of the server device illustrated in FIG. 2A; and

FIGS. 3-54 illustrate various screen shots according to an exemplary embodiment of the present invention.

### DETAILED DESCRIPTION OF THE EXEMPLARY EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, enterprise technologies, middleware, development interfaces, hardware, etc., in order to provide a thorough understanding of the present invention. However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, enterprise applications, operating systems, enterprise technologies, middleware, development interfaces, and hardware are omitted so as not to obscure the description of the present invention.

To facilitate a complete understanding of the present invention, the description of the preferred embodiment is arranged within the following sections:
I. GLOSSARY OF TERMS
II. APPLICATION ARCHITECTURE
III. SYSTEM COMPONENTS AND OPERATION
IV. PMI APPLICATION
V. CONCLUSION
   I. Glossary of Terms

The following terms are used throughout the detailed description:

Client-user device (interchangeable with Laboratory system or Service provider system). Any party, third party or facility that provides tests, information, consultation, analysis, services or products to a physician system or any other system.

Server device (interchangeable with Physician system or Practice Management System or PMS). Any doctor, physician, doctor office, physician office, clinic, facility, medical institution, medical university, university, or any other entity that interacts with a patient in any aspect.

Database. A text data collection or any collection of information.

Internet. A collection of interconnected (public and/or private) networks that are linked together by a set of standard protocols (such as TCP/IP and HTTP) to form a global, distributed network. As will be appreciated by those skilled in the art, the internet may be an intranet, public network, private network, and the like. While this term is intended to refer to what is now commonly known as the internet, it is also intended to encompass variations which may be made in the future, including changes and additions to existing standard protocols.

II. Application Architecture

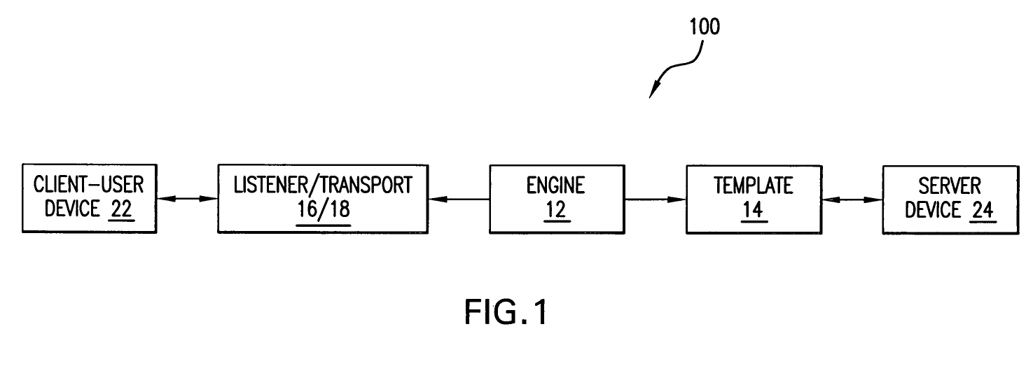

FIG. 1 is functional block diagram of the application architecture according to an exemplary embodiment of the present invention. Referring to FIG. 1, a Practice Management Interface (PMI) 100 consists of four modules: engine 12, template 14, transport 16 and listener 18. These modules translate data from Practice Management Systems (PMS), such as physician systems 24, directly to other applications running on service provider systems 22. The PMI 100 handles the transfer of patient information and data in a protected, non-intrusive process.

The engine 12 provides both supervisory and data processing functions by acting as a central executive that manages and sequences the modules within the PMI 100. The engine 12 operates on the data, maintains the internal database and audit logs of the PMI 100, and provides the user interface through which the PMI parameters are maintained. The engine 12 also provides enhanced task scheduling management, data broker services, automatic maintenance, and enforced security. The engine 12 is based on a client/service framework capable of supporting TCP/IP based applications, file sharing extractions, and antiquated UNIX terminal connections.

The template module 14 interfaces to the database stored at the physician system 24 by plug-in processes, e.g., templates, and provides the means by which the PMI 100 extracts patient information. Each template is unique to and efficiently integrates with a specific PMS 24. The templates are designed to limit the strain on PMSs 24, which are generally pushed beyond capacity. The templates read native database formats, and return normalized datasets or deliver extracted data to the PMI 100 for processing by the engine 12. The templates never write to a PMS database; only “read-only” access is available.

In the exemplary embodiment of the present invention, the templates have one of two formats: Full Record Extraction (FRE) and Single Record Extraction (SRE). The FRE template extracts the required data items upon first operation and, on successive polls, tracks changes such that only new or changed data is sent. Preferably, the FRE templates are compatible with Windows and UNIX based installations wherein the PMS 24 has a network interface card (NIC) and supports file-system mapping.

The SRE templates dynamically retrieve data for a single patient or individual. Network based configurations are compatible with Windows and UNIX based SRE templates, and serial or terminal based configurations are compatible with UNIX based SRE templates.

The transport module 16 is a communications interface unique to each customer-based or lab application running on the service provider system 22. The transport module 16 normalizes and formats the PMS data to a form that the lab application can read, and delivers the data to the lab application of the service provider system 22. Each service provider defines their own unique transport specification. Using the PMI extensible framework of the present invention, application specifications are developed directly into the PMI software application. The transport can be in any format desired including, but not limited to, HL7 or XML, and any type of data connection including SSH.

The listener module 18 is a communication interface used to accept an incoming network base request (socket); preferably, a single patient query. The listener is generally unique to each customer and is based on a predefined query and transport response.

III. System Components and Operation

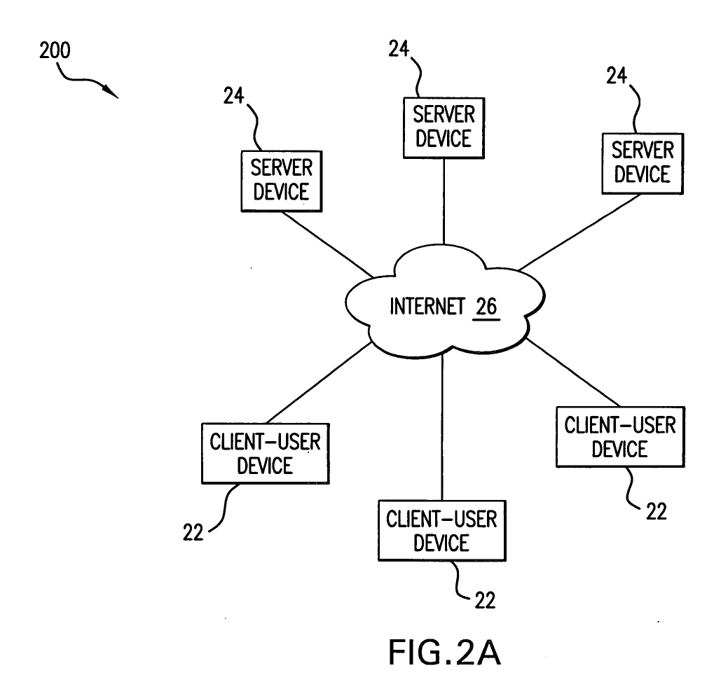

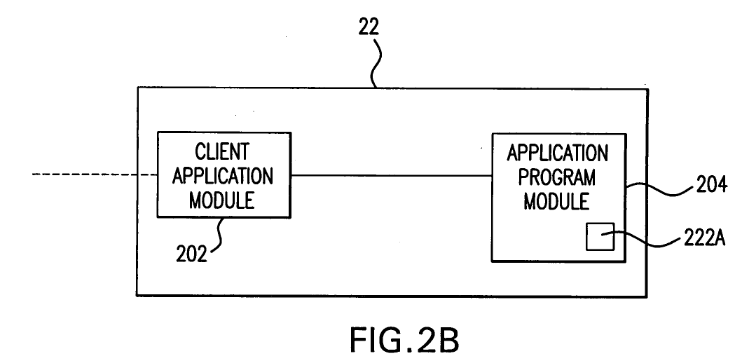

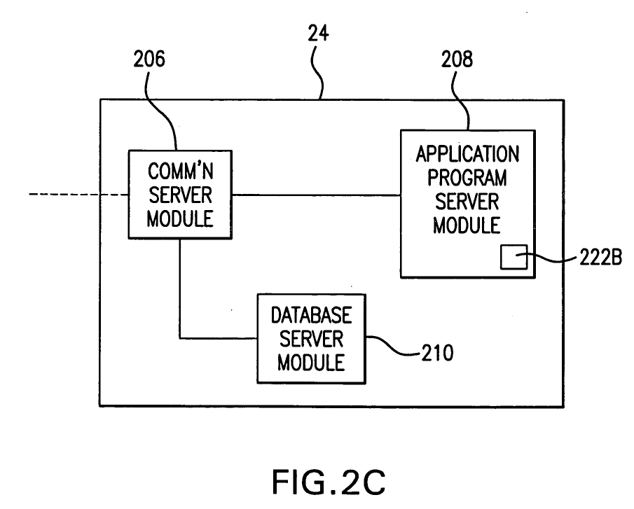

Referring now to FIG. 2A, a functional block diagram of the architecture for an information retrieval system and a method of identifying and extracting information from dissimilar systems and applications according to an exemplary embodiment of the present invention is provided. The information retrieval system 200 includes a client-user device 22 and a server device 24. In the exemplary embodiment, the client-user device 22 and the server device 24 are adapted to communicate over the internet 26.

In other embodiments, the client-user device 22 and the server device 24 can be serially connected. For example, serial connections are utilized for SRE installs. If the client-user device 22 is serially connected to the server device 24, then a serial cable from the client-user device 22 to the server device 24 or to a serial hub is required. A second serial cable may be connected from the client-user device 22 to the server device 24 depending on the service provider's configuration.

In an implementation described herein and as shown in FIG. 2B, the client-user device 22 includes a client application module 202, which may be, for example, a web browser, and an application program module 204 that runs software (e.g., lab application) 222A on the client-user device 22. In an alternate embodiment, the client-user device 22 can communicate with a computer 28 having an application program module that runs the lab application 222A. The client-user device 22 may be any type of computing device that allows a user to interactively browse the internet 26 or interact with the server device 24.

Referring to FIG. 2C, the server device 24 includes a communication server module 206, an application program server module 208, and a database server module 210. The server device 24 may be comprised of one or more computers that are capable of functioning as servers. In an exemplary embodiment of the present invention, the server device 24 includes a communication server device for implementing the communication server module 206, an application program server device for implementing the application program server module 208, and a database server device for implementing the database server module 210.

The communication server device running the communication server module 206 acts as a web server and communicates with the client-user device 22 over the internet 26. The application program server module 208 includes software (e.g., host listening application) 222B running on the server device 24. The database server module 210 includes data structures that define how databases are set up and how information (including spatial and non-spatial data) is stored in and retrieved by the information retrieval system 200. In the exemplary embodiment, the database is a highly centralized relational database, which is highly normalized, and includes an audit mechanism and database authorization.

The server device 24 is configured to allow network file sharing, and the client-user device 22 has a permanent share mapping. Preferably, a file share is created on the server device 24, such that the patient information is available to more than one client-user. Accordingly, the database stored at the server device 24 can be read directly without placing an undue burden on the server device 24. If the server device 24 is Windows based, then no additional software is required for file sharing. If the server device 24 is UNIX based, then additional file sharing software, such as Omni-Lite, is required.

In operation, a socket based methodology can be implemented for communication between the client-user device 22 and the server device 24. For example, the lab application 222A running on the client-user device 22 connects to a socket based interface, which is configured to the lab application 222A, listening on a pre-configured PORT at the server device 24. Once the connection has been authenticated, the lab application 222A sends an HL7 message query/network base data request requesting patient information using HL7 query definitions, as illustrated, for example, in Tables 1 and 2 below. The listener processes the query and sends a HL7 message response using HL7 query definitions, as illustrated, for example, in Tables 3A-10 below.

In an alternate embodiment, a programmatic based methodology can be implemented wherein programmatic interfaces, such as Microsoft COM, can be used on an as required basis.

Tables 1 and 2 (PMI Data Request Specification) describe the formatting for a SRE of patient information from the server device 24.

Demographic Query Request Segment Definitions

TABLE 1
(Message Header Segment (MSH))

| | | | (I)nput | | |
|---|---|---|---|---|---|
| Field | | Required | (O)utput | Max HL7 2.3 | |
| Mnemonic | Use/Value Field | Field | (U)used | Size | Delimiter |
| MSH-0 | Segment Type ID | R | I | N/A | (I) |
| | Always “MSH” | | | | |
| MSH-1 | Delimiter Definition | R | I | 4 | (I) |
| | Always “\hat{ }˜?&” | | | | |
| MSH-2 | Sending Application | R | I | 180 | (I) |
| | Provided by service | | | | |
| | provider to Vendor | | | | |
| MSH-3 | Sending Facility | O | I | 180 | (I) |
| MSH-4 | Receiving Application | R | I | 180 | (I) |
| | Always “PMI” | | | | |
| MSH-5 | Receiving Facility | O | I | 180 | (I) |
| MSH-6 | Message Date/Time | R | I | 26 | (I) |
| | Format is | | | | |
| | “YYYYMMDDHHMM” | | | | |
| MSH-7 | Message Key | R | I | 30 | (I) |
| | License req'd and | | | | |
| | supplied by Vendor | | | | |
| MSH-8 | Message Type | | | 7 | |
| | Message Type | | | | |
| | Always “QRY” | R | I | | (\hat{ }) |
| | Trigger Event | | | | |
| | Always “Q01” | R | I | | (I) |
| MSH-9 | Message Control ID | O | I | 20 | (I) |
| | A unique identifier | | | | |
| | is assigned by | | | | |
| | service provider/ | | | | |
| | host listening | | | | |
| | application for | | | | |
| | message that was | | | | |
| | sent. Used to | | | | |
| | validate that query | | | | |
| | response message was | | | | |
| | generated for its | | | | |
| | query request. | | | | |
| MSH-10 | Processing ID | R | I | 3 | (I) |
| | Always “P” for | | | | |
| | Production | | | | |
| MSH-11 | Version | R | I | 8 | (CR) |
| | Always “2.3” = Release | | | | |
| | 2.3 | | | | |

TABLE 2
(Query Definition Segment (QRD))

| | | | (I)nput | | |
|---|---|---|---|---|---|
| Field | | Required | (O)utput | Max HL7 2.3 | |
| Mnemonic | Use/Value Field | Field | (U)used | Size | Delimiter |
| QRD-0 | Segment Type ID | R | I | N/A | (I) |
| | Always “QRD” | | | | |
| QRD-1 | Query Date/Time | R | I | 26 | (I) |
| | Format is | | | | |
| | “YYYYMMDDHHMM” | | | | |
| QRD-2 | Query Format | R | I | 1 | (I) |
| | Always “R” for | | | | |
| | Record | | | | |
| QRD-3 | Query Priority | R | I | 1 | (I) |
| | Always “I” for | | | | |
| | Immediate | | | | |
| QRD-4 | Query ID | O | I | 10 | (I) |
| | Unique identifier | | | | |
| | for Query Request. | | | | |
| | Use same values as | | | | |
| | MSH-9. | | | | |
| QRD-5 | Unused | N | U | | (I) |
| QRD-6 | Unused | N | U | | (I) |
| QRD-7 | Quantity Limit Request | | | 10 | |
| | Quantity Limit | | | | |
| | Always“1” | R | I | | (\hat{ }) |
| | Quantity Type | | | | |
| | Always “RD” | R | I | | (I) |
| QRD-8 | Who Subject Filter | R | I | 60 | (I) |
| | Patient ID for the | | | | |
| | patient being | | | | |
| | requested | | | | |
| QRD-9 | What Subject Filter | R | I | 60 | (I) |
| | Always “DEM” for | | | | |
| | Demographic Queries | | | | |
| QRD-10 | What Department Code | R | I | 60 | (I) |
| | Use Vendor specified | | | | |
| | ID | | | | |
| QRD-11 | Unused | N | U | | (I) |
| QRD-12 | Query Results Level | O | I | 1 | (CR) |
| | Always “T” for Full | | | | |
| | Records | | | | |

Tables 3A-10 (PMI Data Output Specification) describe the formatting for a SRE and FRE of patient information extracted from the server device 24.

Segment Definitions

MSH Segment—Message Header

Example:

MSH|\hat{ }˜\&|YOURLAB|000/000||PMI|2002071117172||ADT\hat{ }A04||P|4.0

TABLE 3A

| Field | Element Name | Value |
|---|---|---|
| 0 | Segment ID | MSH |
| 1 | Field Separator | \| |
| 2 | Encoding characters | \hat{ }˜\& |
| 3 | Sending Application | Always “PMI” |
| 4 | Sending Facility ID | [See Below] |
| 5 | Receiving Application | Service Provider |
| | | (same as MSH-2 from |
| | | query request) |
| 6 | Receiving Facility ID | [See Below] |
| 7 | Message Date/Time | Date/Timestamp in |
| | | format: |
| | | YYYYMMDD [HHMMSS] |
| 8 | Security | <Not Used> |
| 9 | Message Type | [See Below] |
| 10 | Message Control ID | Same as MSH-9 in |
| | | query request |
| 11 | Processing ID | P |
| 12 | Version ID | 2.3 |

TABLE 3B

| | |
|---|---|
| MSH-4 | Sending Facility ID - Name of client sending |
| | data. This may be account number, name, etc. |
| | (based on option within original query) |
| MSH-6 | Receiving Facility ID - Name of application |
| | receiving data. This may be account number, |
| | name, etc. (based on option within original |
| | query) |
| MSH-9 | Message Type - ADT\hat{ }A04 |
| | specifies new record, ADT\hat{ }A08 |
| | specifies modified record |

EVN Segment—Event Common
Example:

EVN|A04|||VENDOR||20020711171721

TABLE 4A

| Field | Element Name | Value |
|---|---|---|
| 0 | Segment ID | EVN |
| 1 | Event Type Code | [See Below] |
| 2 | Recorded Date/Time of | <Not Used> |
| | Event | |
| 3 | Recorded Date/Time | <Not Used> |
| | Planned Event | |
| 4 | Event Reason Code | VENDOR |
| 5 | <Not Used> | <Not Used> |
| 6 | Event Occurred | Date/Timestamp in |
| | | format: |
| | | YYYYMMDD [HHMMSS] |

TABLE 4B

| | |
|---|---|
| EVN-1 | Event Type Code - A04 specifies new record, A08 |
| | specifies modified record |

PID Segment—Patient Identification
Example:

PID||4.0|4.0||Picon\hat{ }Gloria\hat{ }C||19280915|F|||1202 B Ropond Rd\hat{ }\hat{ }Ronkonkoma\hat{ }NY\hat{ }11779||(631)737-0843|||O|||284324699|Dr. Kevin Barnes |00012||||||||||

TABLE 5A

| Field | Element Name | Value |
|---|---|---|
| 0 | Segment ID | PID |
| 1 | Set ID | <Not Used> |
| 2 | External Patient Account/ID | [See Below] |
| | Number | |
| 3 | Internal Patient Account/ID | [See Below] |
| | Number | |
| 4 | Alternate Patient | <Not Used> |
| | Account/ID Number | |
| 5 | Patient Name | [See Below] |
| 6 | Mother's Maiden Name | <Not Used> |
| 7 | Patient Date of Birth | [See Below] |
| 8 | Patient Sex | [See Below] |
| 9 | Patient Alias | <Not Used> |
| 10 | Patient Ethnic Group | <Not Used> |
| 11 | Patient Address 1 | [See Below] |
| 12 | Patient Country Code | <Not Used> |
| 13 | Patient Phone - Home | [See Below] |
| 14 | Patient Phone - Business | <Not Used> |
| 15 | Patient Language | <Not Used> |
| 16 | Patient Marital Status | [See Below] |
| 17 | Patient Religion | <Not Used> |
| 18 | Patient Account Number | <Not Used> |
| 19 | | <Not Used> |
| 20 | Patient Social Security | [See Below] |
| | Number (Driver's License | |
| | number) | |
| 21-23 | | <Not Used> |
| 24 | Physician of Record | [See Below] |
| 25 | UPIN | [See Below] |
| 26-30 | <Not Used> | <Not Used> |

TABLE 5B

| | |
|---|---|
| PID-2 | Patient Account/ID Number - The unique |
| | identifier of patient in PMS. Some systems have |
| | internal and external account numbers; Vendor |
| | only extracts one account number, which is |
| | assigned internally and cannot be duplicated. |
| PID-3 | Duplicate of above |
| PID-5 | Patient Name - Formatted as Last Name\hat{ }First |
| | Name\hat{ }Middle Initial |
| PID-7 | Patient Date of Birth - Formatted as YYYYMMDD |
| PID-8 | Patient Sex - M or F |
| PID-11 | Patient Address 1 - Formatted as Address Line |
| | 1\hat{ }Address Line 2\hat{ }City\hat{ }State\hat{ }Zip Code |
| PID-13 | Patient Phone (Home) - Formatted as (555) 555- |
| | 5555 |
| PID-16 | Patient Marital Status - Either A, D, M, S or W |

| | |
|---|---|
| Value | Description |
| A | Separated |
| D | Divorced |
| M | Married |
| S | Single |
| W | Widowed |

| | |
|---|---|
| PID-20 | Patient Social Security Number - No formatting. |
| | Example - 284324699 |
| PID-24 | Physician of Record - Patient's Physician - |
| | Formatted as is in PMS - Dr. Kevin Barnes |
| | (Non-HL7 Standard Placement) |
| PID-25 | UPIN - Physician ID - 00012 |
| | (Non-HL7 Standard Placement) |

GT1 Segment—Guarantor Identification
Example:

GT1||4.0|Picon\hat{ }Gloria\hat{ }C||1202 B Ropond Rd\hat{ }\hat{ }Ronkonkoma\hat{ }NY\hat{ }11779|(631)737-0843||19280915|F||S|284324699|||||||||||||||||||||||||||||||||

TABLE 6A

| Field | Element Name | Value |
|---|---|---|
| 0 | Segment ID | GT1 |
| 1 | Set ID | <Not Used> |
| 2 | Guarantor Account/ID Number | [See Below] |
| 3 | Guarantor Name | [See Below] |
| 4 | Guarantor Spouse Name | <Not Used> |
| 5 | Guarantor Address 1 | [See Below] |
| 6 | Guarantor Phone - Home | [See Below] |
| 7 | Guarantor Phone - Business | <Not Used> |
| 8 | Guarantor Date of Birth | [See Below] |
| 9 | Guarantor Sex | M or F |
| 10 | Guarantor Type | <Not Used> |
| 11 | Guarantor Relationship | [See Below] |
| 12 | Guarantor Social Security | [See Below] |
| | Number | |
| 13-55 | <Not Used> | <Not Used> |

TABLE 6B

| | |
|---|---|
| GT1-2 | Guarantor Account/ID Number (if available) - The |
| | unique identifier of Guarantor in PMS. Some |
| | systems have internal and external account |
| | numbers; Vendor only extracts one account |
| | number, which is assigned internally and cannot |
| | be duplicated. |
| GT1-3 | Guarantor Name - Formatted as Last Name\hat{ }First |
| | Name\hat{ }Middle Initial |
| GT1-5 | Guarantor Address 1 - Formatted as Address Line |
| | 1\hat{ }Address Line 2\hat{ }City\hat{ }State\hat{ }Zip Code |
| GT1-6 | Guarantor Phone (Home) - Formatted as (555)555- |
| | 5555 |
| GT1-8 | Guarantor Date of Birth - Formatted as YYYYMMDD |
| GT1-11 | Guarantor Relationship - Either E, C, S, O or U |

| | |
|---|---|
| Value | Description |
| E | Self |
| C | Child |
| S | Spouse |
| O | Other |
| U | Undefined |

| | |
|---|---|
| GT1-12 | Guarantor Social Security Number - No |
| | formatting. Example - 284324699 |

IN1 Segment—Insurance Identification (Primary)
Example:

IN1|1|DCBS19||BlueCross BlueShield|POBox 1407 Church St\hat{ }\hat{ }New York\hat{ }NY\hat{ }100081407||(800)552-6630|550090-951||||||||||Fuentes\hat{ }Kevin\hat{ }F|E|19280915|301 Robinson Ave Apt#2\hat{ }\hat{ }East Patchogue\hat{ }NY\hat{ }11772||F||||||||||||||||||||YLN076888950

TABLE 7A

| Field | Element Name | Value |
|---|---|---|
| 0 | Segment ID | IN1 |
| 1 | Set ID | [See Below] |
| 2 | Insurance Plan Code/ID | [See Below] |
| 3 | Insurance Carrier Code/ID | <Not Used> |
| 4 | Insurance Name | [See Below] |
| 5 | Insurance Address 1 | [See Below] |
| 6 | Insurance Contact | <Not Used> |
| 7 | Insurance Phone | [See Below] |
| 8 | Insurance Group Plan | [See Below] |
| | Number | |
| 9 | Insurance Group Name | <Not Used> |
| 10 | Insurance Group Employer | <Not Used> |
| | ID | |
| 11 | Insurance Group Employer | <Not Used> |
| | Name | |
| 12 | Plan Effective Date | <Not Used> |
| 13 | Plan Expiration Date | <Not Used> |
| 14 | Authorization Information | <Not Used> |
| 15 | Insurance Plan Type | <Not Used> |
| 16 | Name of insured | [See Below] |
| | (Subscriber Name) | |
| 17 | Subscriber Relationship | [See Below] |
| 18 | Subscriber Date of Birth | [See Below] |
| 19 | Subscriber Address 1 | [See Below] |
| 20-42 | <Not Used> | <Not Used> |
| 43 | Subscriber Sex | M or F |
| 44-48 | <Not Used> | <Not Used> |
| 49 | Subscriber INS ID Number | [See Below] |

TABLE 7B

| IN1-1 | Set ID - Delineates Primary (1) or Secondary | |
|---|---|---|
| | Insurance (2). | |
| IN1-2 | Insurance Plan Code/ID - Abbreviated Insurance | |
| | Plan Code + Plan number (to keep as unique) for | |
| | particular Carrier. | |
| IN1-4 | Insurance Name - This is name of Insurance | |
| | Company as defined in PMS. | |
| IN1-5 | Insurance Address 1 - Formatted as Address Line | |
| | 1\hat{ }Address Line 2\hat{ }City\hat{ }State\hat{ }Zip Code | |
| IN1-7 | Insurance Phone (Home) - Formatted as (555)555- | |
| | 5555 | |
| IN1-8 | Insurance Group Plan Number - This is | |
| | Subscriber's Group Plan Number for specified | |
| | Insurance Policy. | |
| IN1-16 | Subscriber Name - The name of Policy Holder. | |
| | Formatted as Last Name\hat{ }First Name\hat{ }Middle Initial. | |
| IN1-17 | Subscriber Relationship - Either E, C, S, O or U. | |
| | Value | Description |
| | E | Self |
| | C | Child |
| | S | Spouse |
| | O | Other |
| | U | Undefined |

| | |
|---|---|
| IN1-18 | Subscriber Date of Birth - Formatted as YYYYMMDD |
| IN1-19 | Subscriber Address 1 - Address for Policy Holder. |
| | Formatted as Address Line 1\hat{ }Address Line |
| | 2\hat{ }City\hat{ }State\hat{ }Zip Code |
| IN1-49 | Subscriber Insurance ID Number - The Policy |
| | Holder's Insurance ID Number. No formatting. |

IN2 Segment—Extended Insurance Information (Primary)
Example:

IN2||76888950|||||||||||||||||||||||||||||||||||(631)289-1688||||||||||

TABLE 8A

| Field | Element Name | Value |
|---|---|---|
| 0 | Segment ID | IN2 |
| 1 | Set ID | [See Below] |
| 2 | Subscriber Social | [See Below] |
| | Security Number | |
| 3-62 | <Not Used> | <Not Used> |
| 63 | Subscriber Phone | [See Below] |
| 64-71 | <Not Used> | <Not Used> |
| 72 | <Not Used> | <Not Used> |

TABLE 8B

| | |
|---|---|
| IN2-1 | Set ID - Delineates extended Primary (1) or |
| | Secondary Insurance (2) information |
| IN2-2 | Subscriber Social Security Number - This is SSN |
| | of Insurance Policy Holder. No formatting. |
| IN2-63 | Subscriber Phone (Home) - Formatted as (555)555-5555 |

IN1 Segment—Insurance Identification (Secondary)
Example:

IN1|2|||Managed Health Care|1331 Robin Blvd.\hat{ }Suite 101\hat{ }New York\hat{ }NY\hat{ }1000811407||(800)444-2300|550090-951||||||||Fuentes\hat{ }Marla\hat{ }F|W|19311015|301 Robinson Ave Apt#2\hat{ }\hat{ }East Patchogue\hat{ }NY\hat{ }11772||||||||||||||||||||YLN076888950

TABLE 9

| Field | Element Name | Value |
|---|---|---|
| 0 | Segment ID | IN1 |
| 1 | Set ID | 2 |
| 2-49 | | Same Elements as |
| | | Primary Insurance |

IN2 Segment—Extended Insurance Information (Secondary)
Example:

IN2|2|7688950|||||||||||||||||||||||||||||||||||||(818)219-7777|||||||||

TABLE 10

| Field | Element Name | Value |
|---|---|---|
| 0 | Segment ID | IN2 |
| 1 | Set ID | 2 |
| 2 | | Same Elements as Extended |
| | | Primary Insurance |

IV. PMI Application

A. Pre-Install Requirements

There are physical conditions that must exist at a site prior to installing and setting up the PMI application. In addition, a site survey is used to determine whether or not the appropriate conditions exist, and to gather information required during the setup of the PMI.

1. Pre-Install Conditions

There are a number of pre-conditions that must be satisfied before the installation of the PMI application. One of the following scenarios will be encountered: (1) a Windows based PMS and a Windows based client-user device, (2) a UNIX based PMS and a Windows based client-user device over a LAN interface connection, and (3) a UNIX based PMS and a Windows based client-user device over a serial/terminal interface connection. While there are similarities among these scenarios, there are differences, not only for PMI configuration, but also physical hardware and software configuration requirements, as discussed in greater detail below.

a. Client-User Device

The PMI application must be installed on a client-user device which supports the Microsoft Operating system, and have the following specifications:
Microsoft Windows 2000 or above are preferred;
An Intel P3 333 MHz minimum, but P4 500 MHz or better suggested;
128 MB minimum and 256 MB or more memory suggested (512 MB or more for sites with very large patient databases);
300 Mbytes or more available disk space;
One NIC (network interface card); and
One serial port (only necessary for SRE serial configurations).

b. LAN (Local Area Network)

For any LAN connection, the client-user device requires a connection to the PMS LAN. Accordingly, there must be an available port on the LAN hub or switch. While the PMI application can exist and run on any system with the appropriate configuration, it should be one with minimal activity.

2. Pre-Install Conditions for Windows-to-Windows Network Installations

The client-user device is installed on the same LAN as and has network access to the PMS. Under some PMS environments, the PMI application runs as a valid Windows Domain user, and requires login access to the Domain and/or database access for SQL based PMS.

3. Pre-Install Conditions for Windows-to-Unix Network Installations

The PMS has a NIC (network interface card) and is configured to and properly operates on the LAN. A read-only access to the database stored on the PMS is available via an “export” of a file-system. For some SRE operations, a network login (e.g., telnet) is configured to access individual patient records.

To properly set up the Unix PMS, a “root” user login password, which is not required for day-to-day operation of the PMI interface but, required only during installation, is required. Also during installation, the exact location of the PMS database must be known, such that “read-only” access for data extraction is provided.

4. Pre-Install Conditions for Windows-to-Unix Serial Installations

Prior to installing the PMI application in older UNIX based systems, the availability of a serial terminal port for use by the client-user device should be verified. A serial cable is required to connect the two computers. Preferably, the connection may be through a terminal server or a direct serial cable (e.g., integrated serial 9 pin interfaces available on most desktop computers). If only a USB port is available, a USB to Serial adapter should be used.

5. Summary of Pre-Install Conditions

Tables 11-14 summarize the PMI pre-install conditions and provide suggested resources to verify the conditions.

TABLE 11
Pre-Install Conditions for the PMI Client-User Device

| Required Conditions | Resources to Verify |
|---|---|
| PMI Client User Device | Check PMI Client User Device |
| Microsoft Windows 2000 or | Manager →> System Properties |
| above | |
| PMI Client User Device has | Check PMI Client User Device |
| PIII 333 (minimum) or above | Manager →> System Properties |
| processor | |
| PMI Client User Device has | Check PMI Client User Device |
| 128 MB (minimum) or more RAM | Manager →> System Properties |
| memory | |
| PMI Client User Device has | Check PMI Client User Device |
| 300 Mbytes or more available | ‘My Computer’, right click, |
| hard disk space | select ‘Properties’ |
| PMI Client User Device has | Visually verify. Check PMI |
| NIC card (for network | Client User Device Manager |
| install) | →> System Properties |
| PMI Client User Device has | Visually verify. Check PMI |
| Serial Port (for serial | Client User Device Manager |
| install) | →> System Properties |

TABLE 12
Pre-Install Conditions for Windows-to-Windows Network Installation

| Required Conditions | Resources to Verify |
|---|---|
| PMI Client User Device is on | Visually verify |
| PMS LAN | |
| PMI Client User Device can | Use network trouble-shooter |
| ping PMS | and ‘ping’ command in |
| | Appendix A |
| PMS Data Directory Shared | |
| PMS LAN user login known (if | Check with Domain |
| required) | Administrator |
| PMS SQL login known (if | Check Templates Fact Sheets |
| required) | (for requirement) and System |
| | Administrator |

TABLE 13
Pre-Install Conditions for Windows-to-UNIX Network Installation

| Required Conditions | Resources to Verify |
|---|---|
| PMS is Unix based | Check with practice |
| | administrator, check |
| | Template Fact Sheet, |
| | visually verify |
| PMS Unix PC has NIC card | Visually verify |
| Cable from PMS NIC card to | Visually verify |
| hub or wall outlet | |
| PMI client-user device can | Use network trouble-shooter |
| ping PMS | and ‘ping’ command in |
| | Appendix A |
| PMS has File Sharing product | Appendix B |
| (NFS) running | |
| Path to PMS data on PMS | Appendix B |
| exported | |
| NFS Client Running (Omni- | Appendix B |
| Lite installed with PMI) | |
| ‘Root’ password (PMS) known | Check with system |
| by practice | administrator |
| Valid user password required | Ask PMS system administrator |
| | to add new account |

TABLE 14
Pre-Install Conditions tor Windows-to-Unix Serial Installation

| Required Conditions | Resources to Verify |
|---|---|
| PMS is Unix based (required | Check with practice |
| for Serial Installation) | administrator, check |
| | Template Fact Sheet, |
| | visually verify |
| Unix based PMS connected to | Visually verify |
| terminals | |
| PMI client-user device has | Visually verify |
| serial port | |
| PMS or Terminal Server has | Visually verify. Appendix A |
| available serial port | |
| PMI client-user device | Visually verify. See |
| connected to PMS via serial | Appendix A for HyperTerminal |
| cable | test. |
| ‘Root’ password (PMS) known | Check with system |
| by practice | administrator |

B. Process for Installing PMI

The install process for the PMI application is the same for all the above scenarios.

1. The PMI Installation Computer Product

The installation computer product contains the following components: PMI Engine, Templates (FRE and SRE), Transport module specific to the service provider, PMI SRE Listener, Omni-Lite and VNC, all of which are not required for installation.

2. InstallShield for PMI

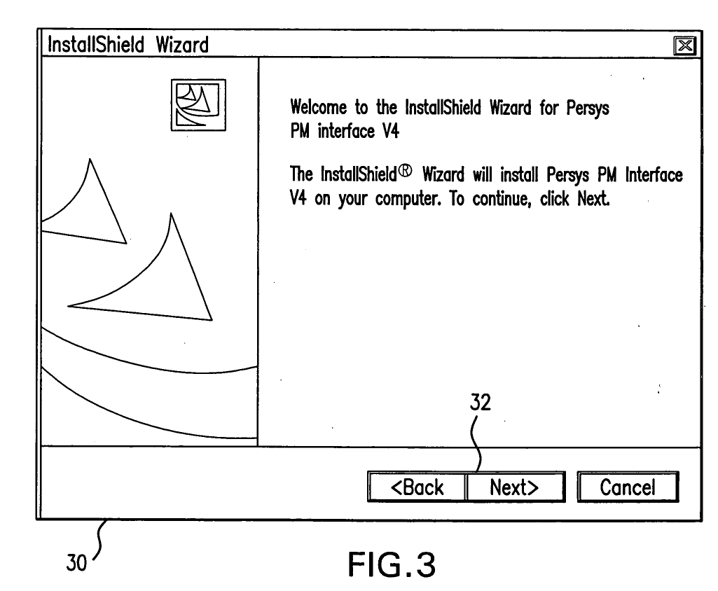

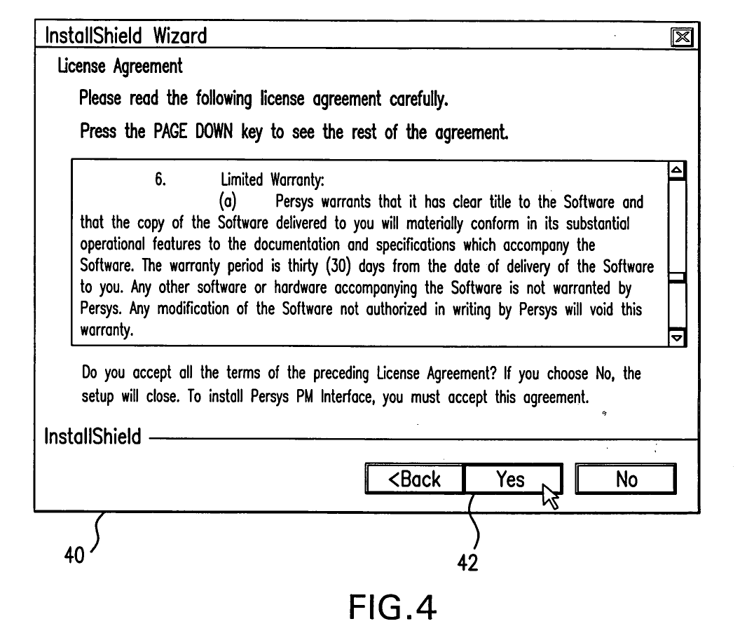

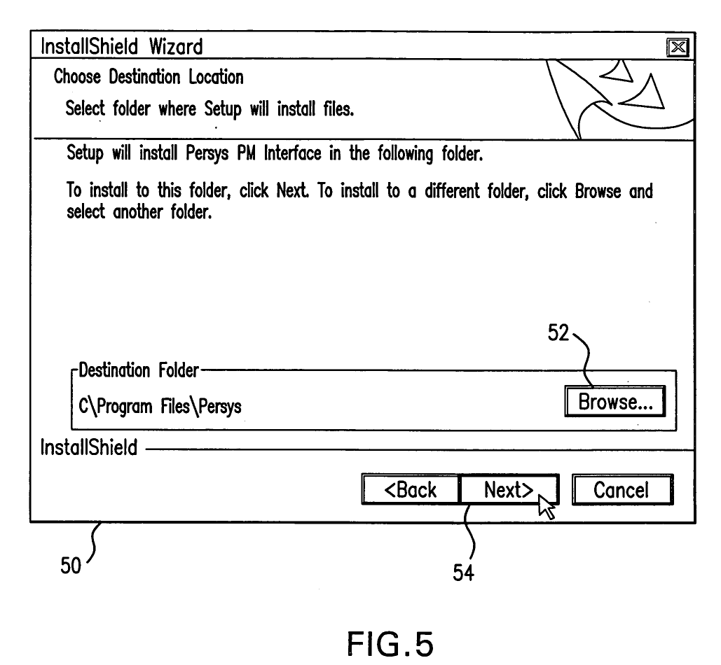

The InstallShield for PMI starts as soon as the computer product is inserted into the computer. A “Welcome” window 30, as illustrated in FIG. 3, is automatically displayed. When a user clicks the “Next” button 32, a license agreement 40 (FIG. 4) is displayed. After the user has carefully reads and accepts the terms of the license agreement, by selecting the “Yes” button 42, a “Choose Destination Location” window 50 (FIG. 5) is displayed.

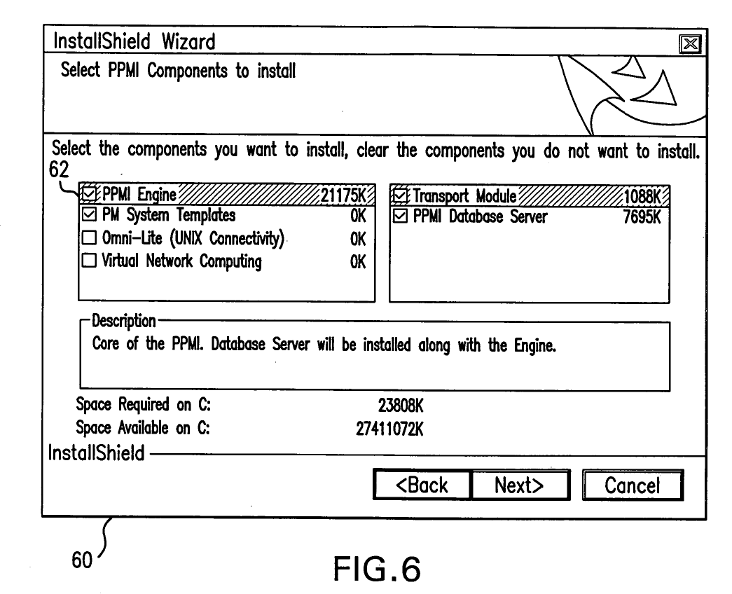

The PMI is installed at the default location unless the user changes the location. Preferably, the default location is used. To change the location, the user clicks the “Browse” button 52 and selects the desired location. Once the location has been determined, the user selects the “Next” button 54, and a “Select PMI Components” window 60 (FIG. 6) is displayed.

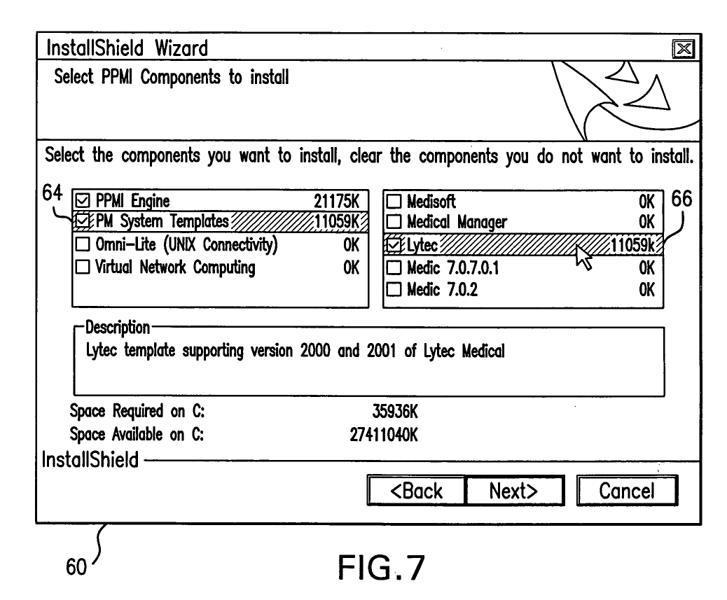

All sub-components of the PMI Engine component 62 (FIG. 6) must be selected in window 60 for the PMI to run. If the user clicks on the PMI System Templates component 64 (FIG. 7) in window 60, he/she can install the template needed for the PMS or server device 24 at a specific site. For example, only the Lytec template 66 has been selected in FIG. 7 and will be installed.

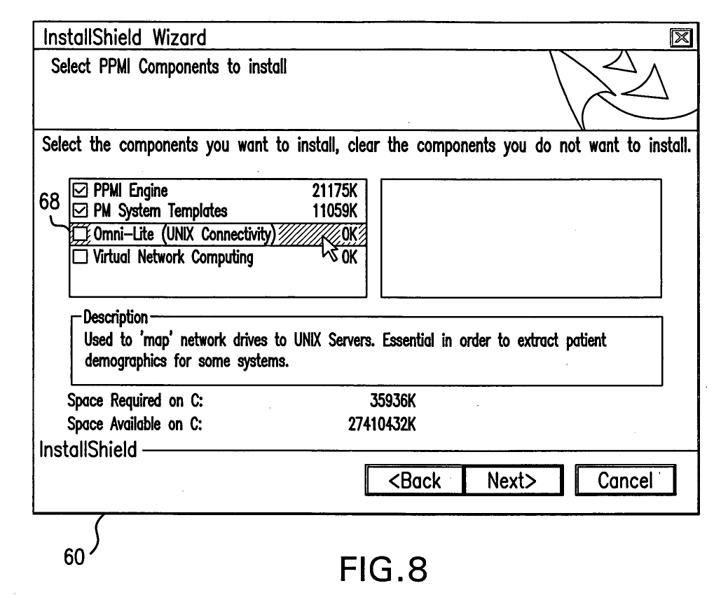

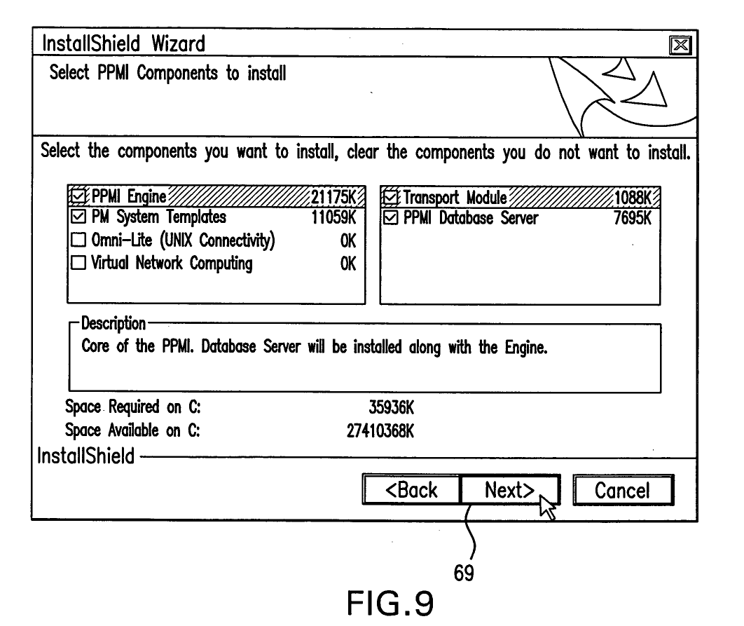

In some cases, as illustrated in FIG. 8, the “Omni-Lite” option 68 may need to be installed when the PMS resides on a UNIX server. The user simply clicks the box next to the “Omni-Lite” option 68 and it is installed. Once all the components have been selected, the user reviews his/her selections (FIG. 9) to ensure that all necessary components are installed.

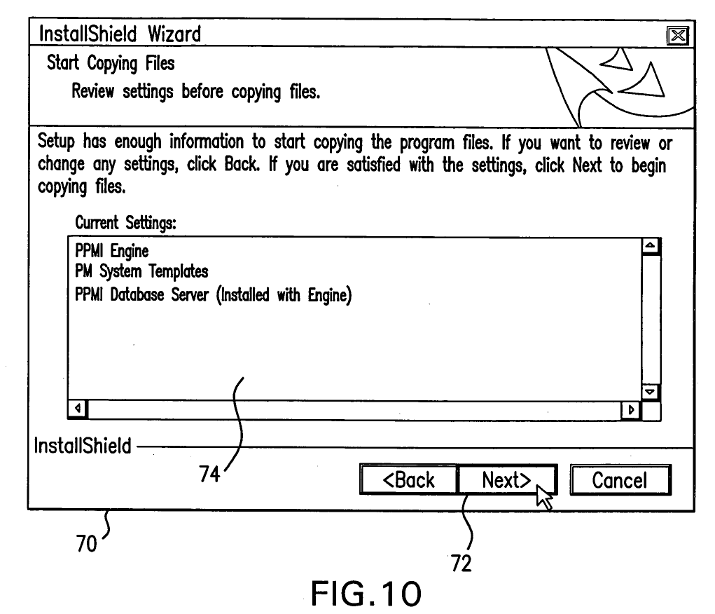

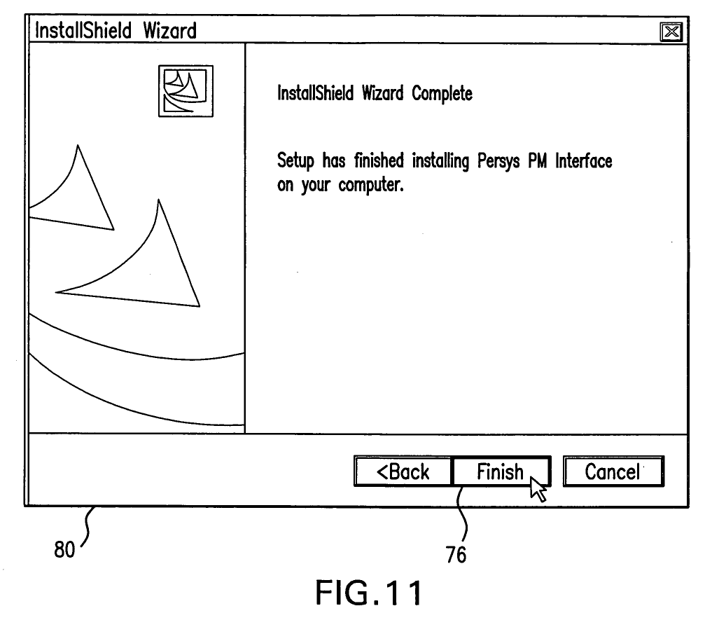

The user clicks the “Next” button 69 to start installation, and a “Start Copying Files” window 70 (FIG. 10) is displayed. When the user selects the “Next” button 72, a “database server installer” window 74 opens and runs, and the PMI Installer temporarily turns off the Interbase server. Once installation has completed, these two functions automatically closes, and an “Installation Complete” window 80 (FIG. 11) is displayed. The user clicks the “Finish” button 76 to close the PMI Installer.

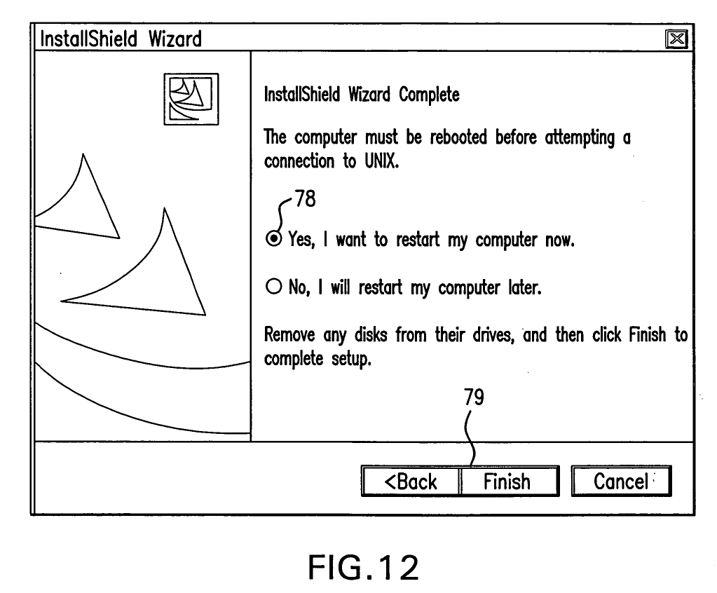

If the user decides to install VNC, after making the appropriate selections, the InstallShield for VNC opens and the user follows the steps in the install process for VNC. If the user decides to install Omni-Lite, the user reboots his/her computer. For example, the user clicks the “Yes” radio button 78, as illustrated in FIG. 12, and the computer restarts. The PMI does not automatically start unless the user reboots the computer. Once finished, the user selects the “Finish” button 79.

C. Setting Up PMI

Setting up PMI to run is the same for all the above scenarios.

1. Setting up FRE (Full Record Extraction) with a Network Connection

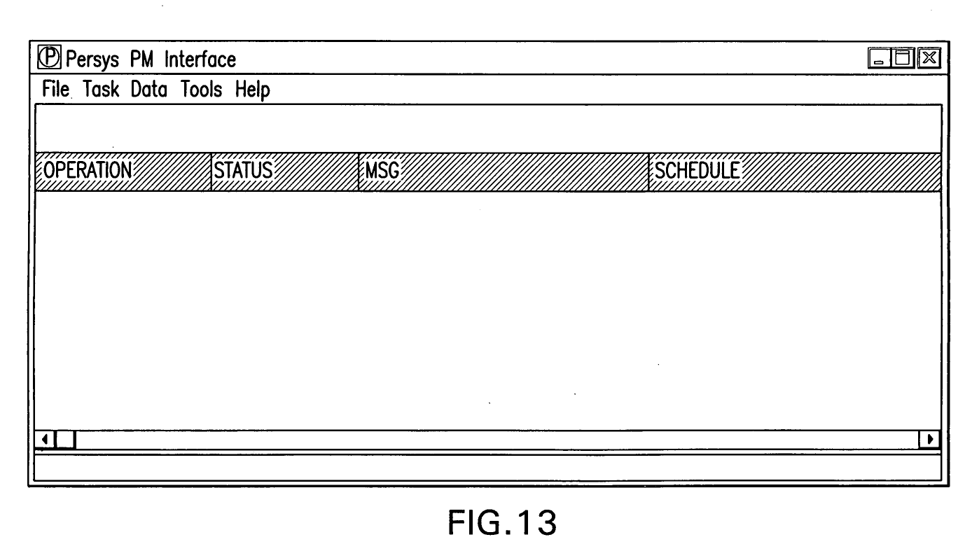

To begin or start the PMI, the user starts from the start menu. As illustrated in FIG. 13, the program starts and displays in the lower left portion of the system icon tray. The user double clicks on the [P] icon to open the PMI. If the computer was rebooted after installation, as discussed above, the [P] icon is displayed in the system icon tray.

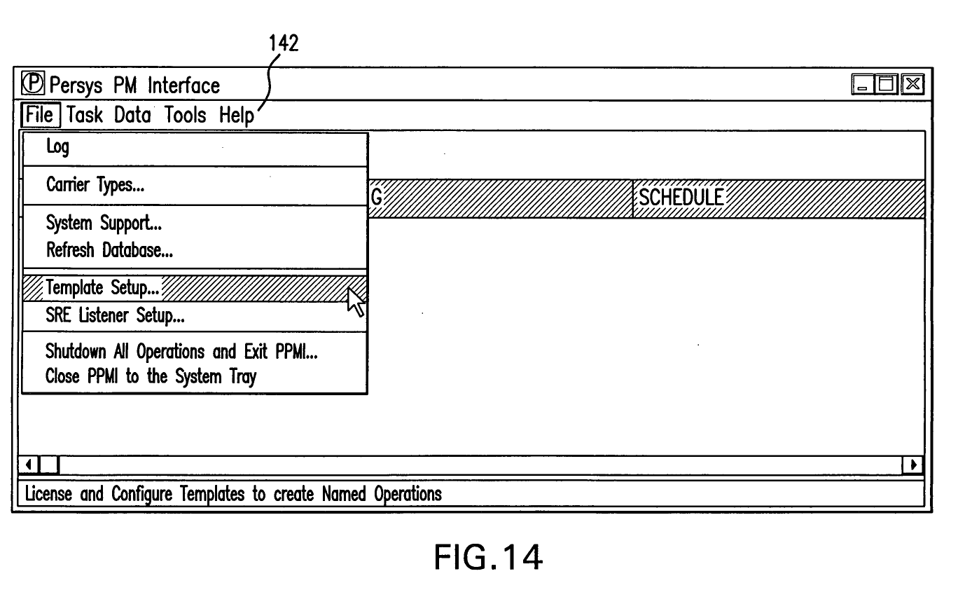

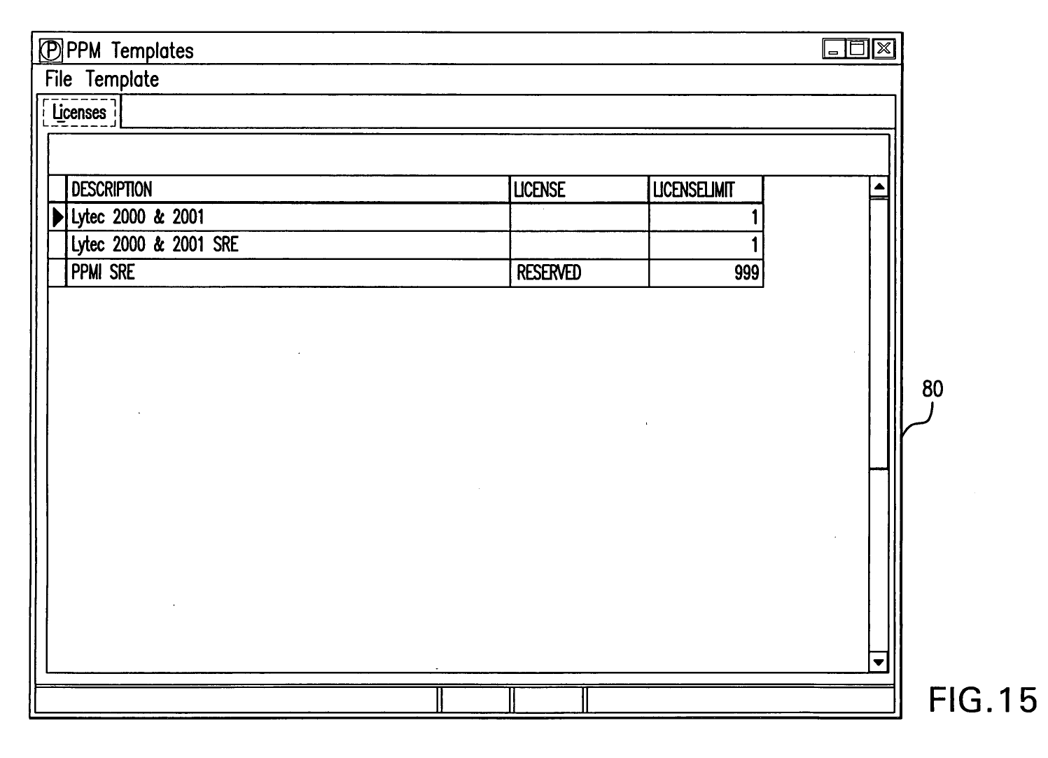

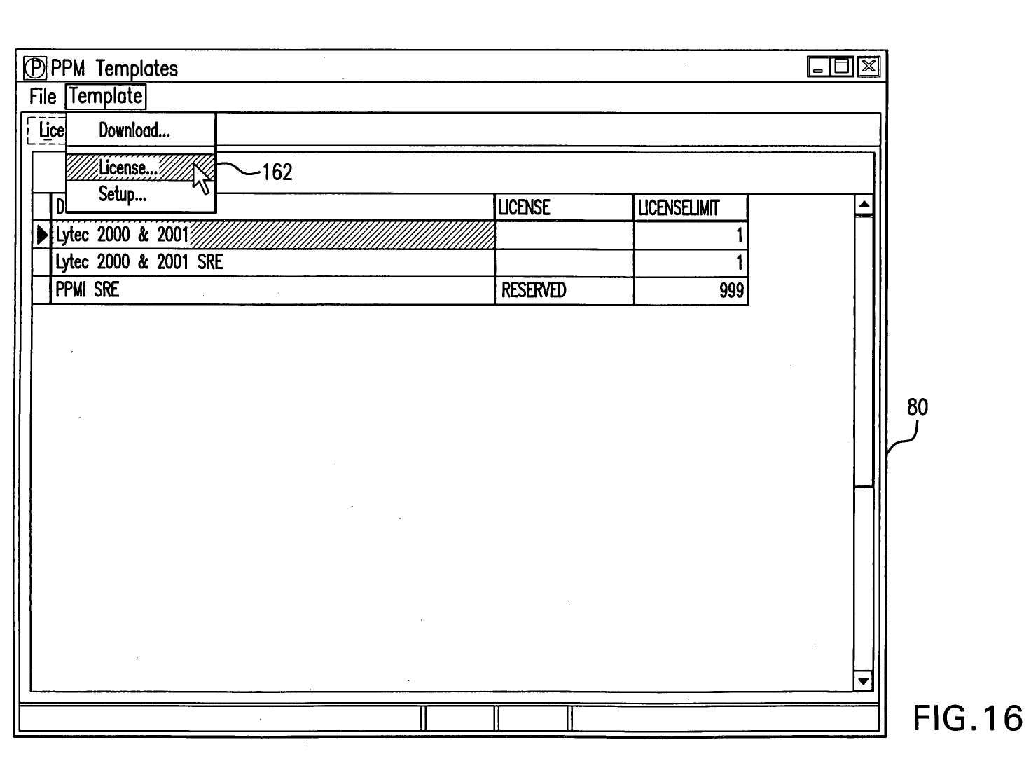

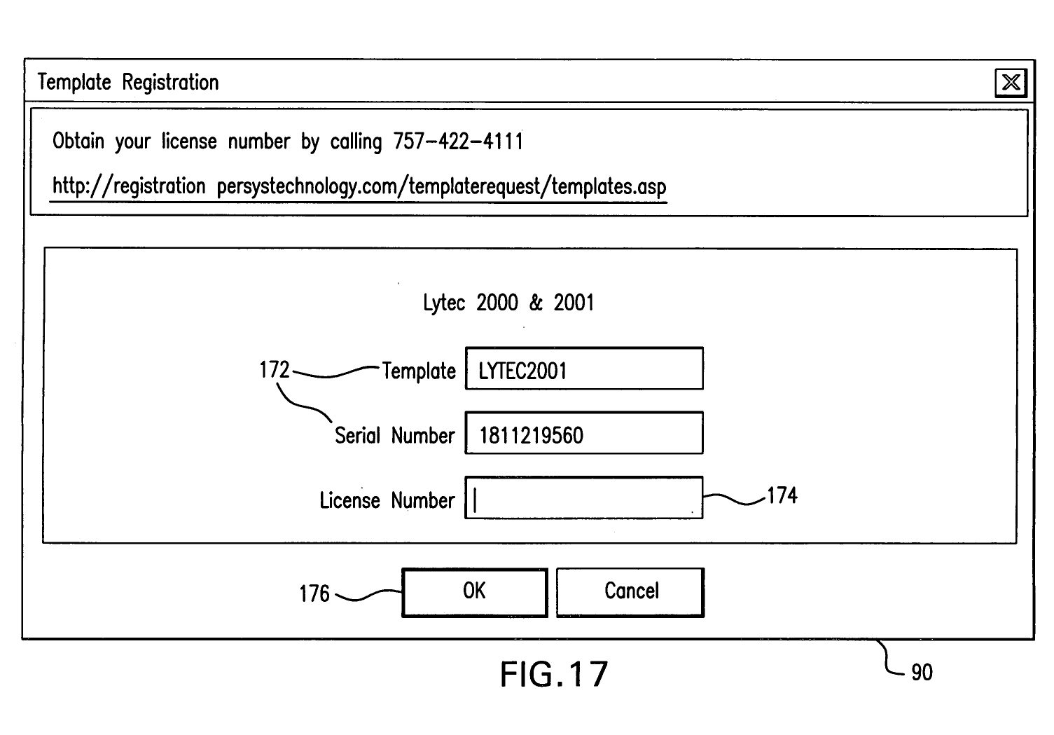

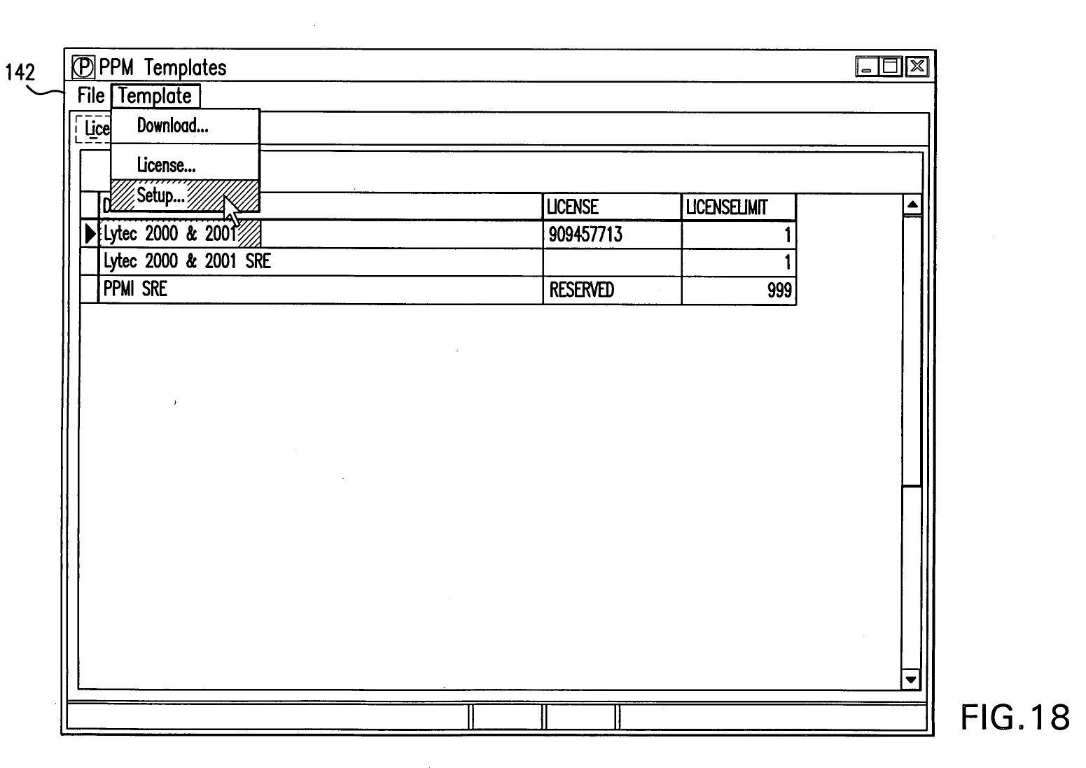

Referring to FIG. 14, the user selects “File” on the toolbar 142 and then selects “Template Setup” to begin the setup process. The “Setup” window 80 (FIG. 15) for the installed template, e.g., Lytec, is opened, and the user selects one of the two Lytec templates. The user highlights the desired template, e.g., Lytec FRE, as illustrated in FIG. 16, and selects “Template” and then “License” from the menu 162. A “Template Registration” window 90 (FIG. 17) is displayed, and the user is instructed to call the vendor to obtain a license number for the PMI. The user provides the vendor with the information, such as the practice and the serial number 172, displayed in the window 90. The vendor then provides the user with a license number, and the user enters the license number in the “License Number” field 174 of the window 90, and clicks the “OK” button 176. A window (not shown) is displayed confirming that the template is licensed. The user clicks the “OK” button (not shown) to continue. Next, the user sets up the parameters for the template to run in FIG. 18.

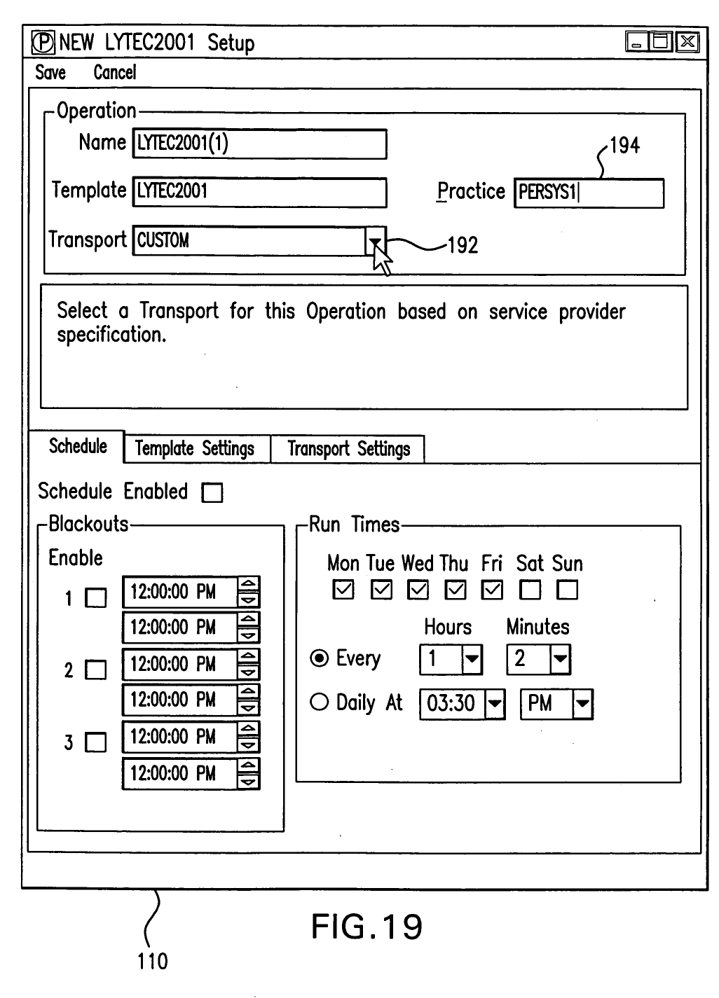

Referring to FIG. 18, the user selects “Template” on the toolbar 142 and then selects “Setup.” A “Setup” window 110 (FIG. 19) is displayed, and the user selects a “Transport” using drop down link 192. The user selects the Transport, e.g., “Custom,” developed specifically for the service provider. Next, the user enters a practice name in the “Practice” box 194 in order for the PMI to differentiate between extracted data sets. A unique entry (e.g., alphanumeric characters) is required for each data set the PMI reads even if one data set is read.

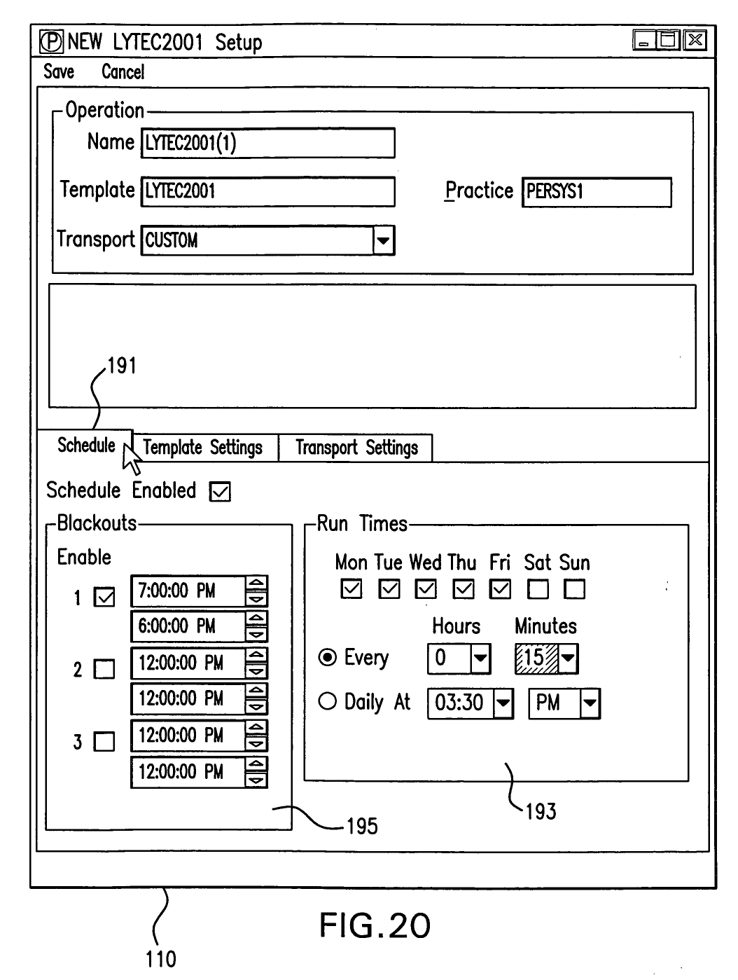

The extraction schedule is set by selecting the “Schedule” tab 191 in FIG. 20. The user selects the “Run Times” (e.g., Mon-Sun) in window 193 by clicking the radio buttons that correspond to the specific day, and run cycle. If the user selects a daily run, he/she selects the specific time using the appropriate drop down box. If the user selects a hourly run, he/she selects the appropriate interval using the appropriate hours/minutes drop down box. For example, as illustrated in FIG. 20, the PMI runs Monday through Friday every fifteen minutes until the last extraction is finished. The user can also select “Blackout” times in window 195 by clicking the radio buttons to enable/disenable specific times. For example, as illustrated in FIG. 20, the PMI shuts down from 7 pm to 6 am.

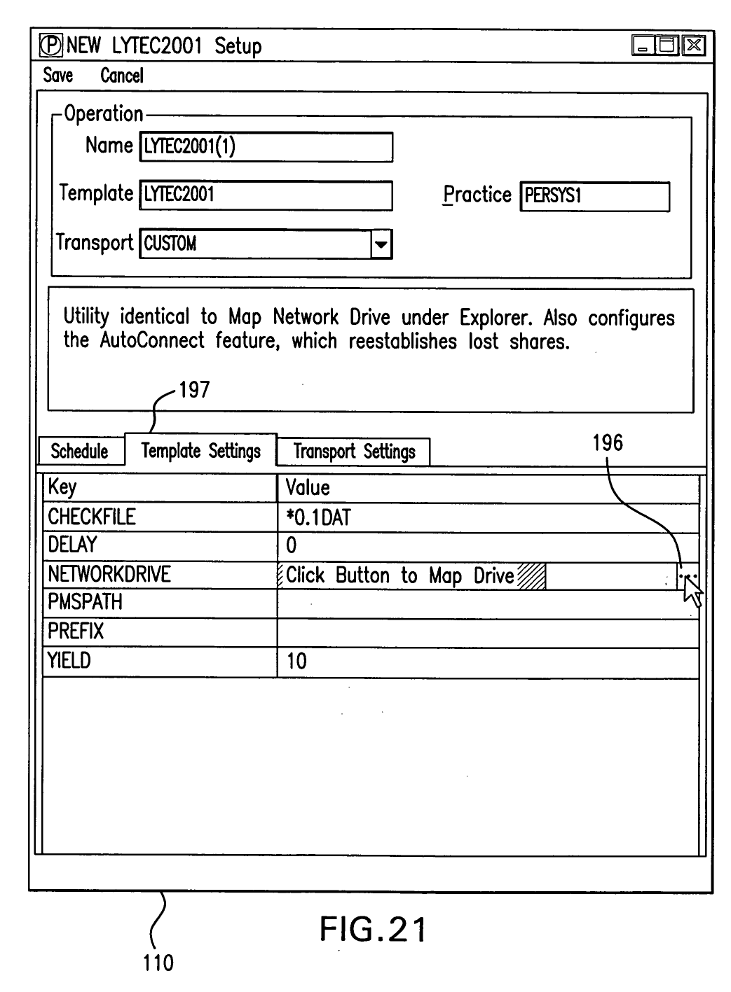

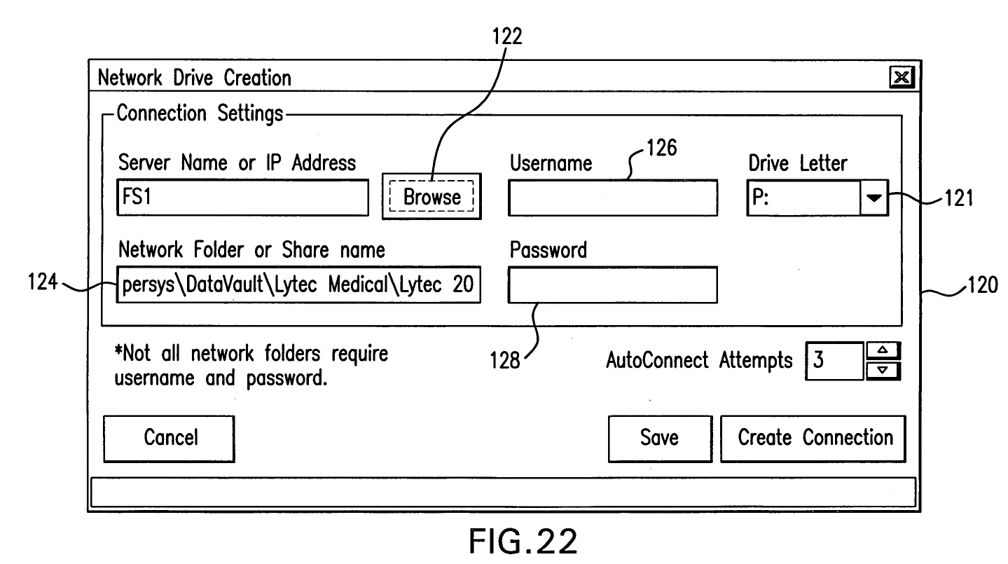

Next, the user points the PMI to the practice data by selecting the “Template Settings” tab 197 in FIG. 21. If a drive to the server has not been mapped, the user double-clicks on button 196 so that the PMI software automatically reconnects shares without user intervention. Then, a “Connection Settings” window 120 (FIG. 22) is displayed where the user enters the requested information, such that a standard drive mapping function is performed.

Once the PMS has been configured to share the PMS data file system, the user enters in either the server name or the IP address of the PMS server to permanently map the drive. The user clicks the “Browse” button 122 to locate the server and network folder for both Windows and UNIX operating systems. The user then types the data directory, which was exported/shared from the PMS server, in the “Network Folder” field 124. In some instances, a user name and password (e.g., data fields 126-128) are required within the window domains to properly map the drive. An available drive letter is selected from the pull down box 121. As shown, the selected drive letter, for example, is “P.”

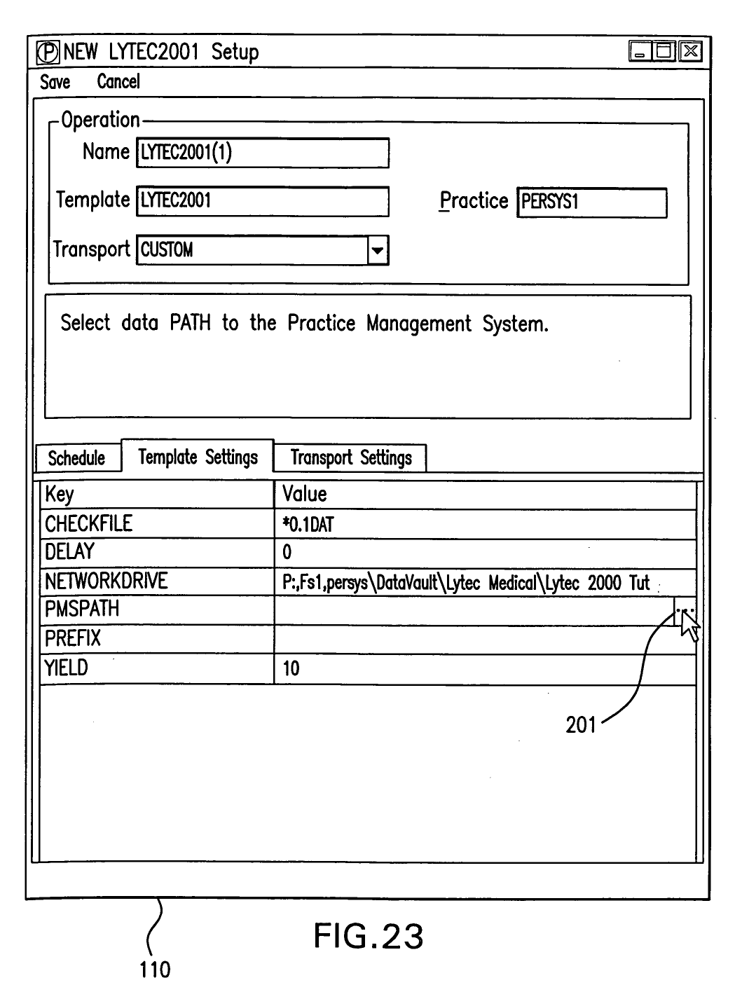

If the drive is mapped, the user double-clicks on drop down button 201 (FIG. 23) to search the network for the practice data. If the drive is mapped using drop down box 196, only the drive letter is selected using drop down box 121.

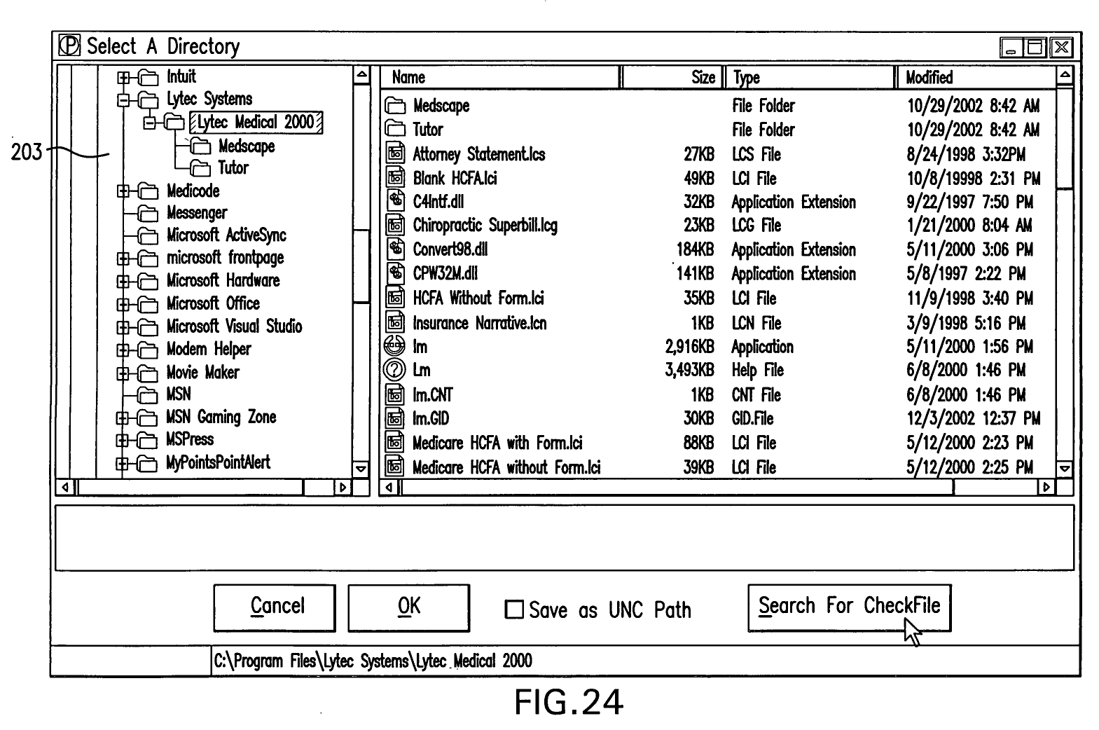

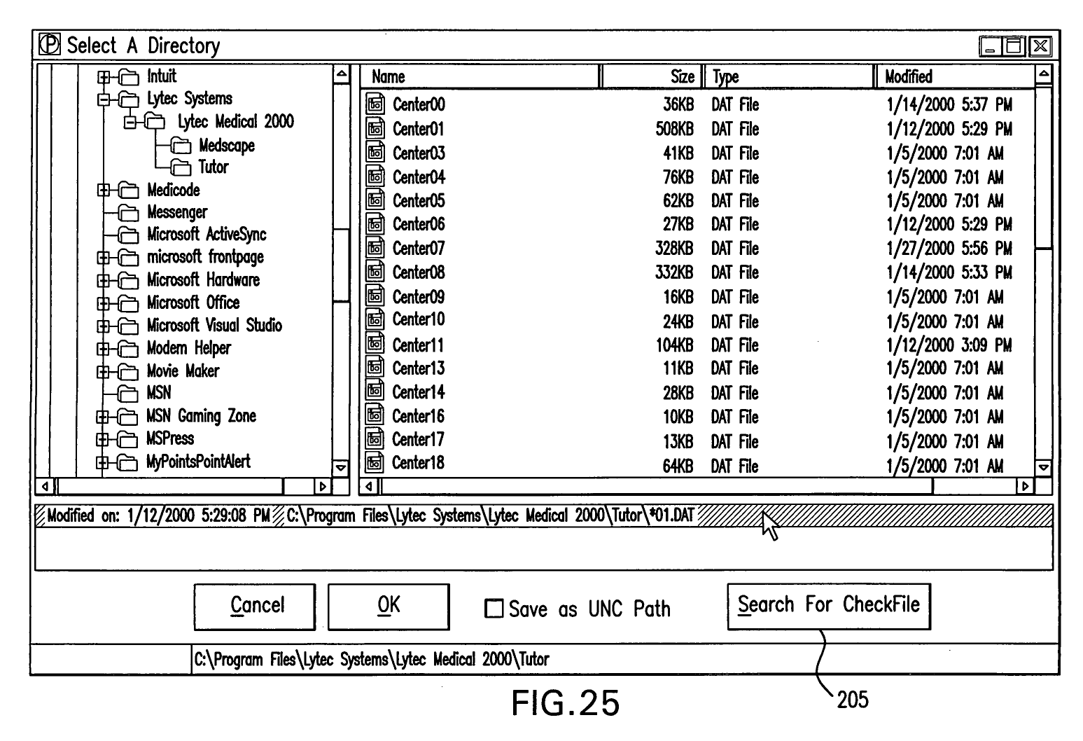

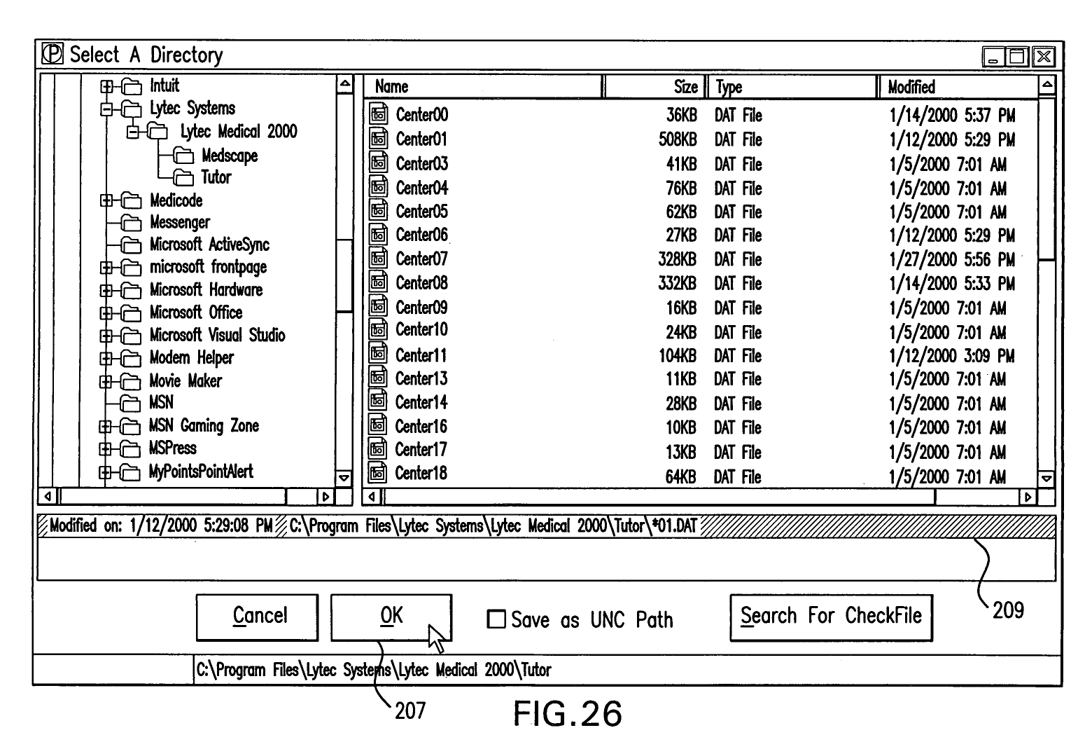

The user navigates into the server to find the appropriate folder by double-clicking on the Drive in window 203 (FIG. 24) where the PMS resides. Once the folder has been highlighted, the user clicks the “Search for Check File” button 205 (FIG. 25) to find the data file, and the data path appears in window 209 (FIG. 26). The user highlights and clicks the data path, and then clicks the “OK” button 207, such that the PMI is pointed to the practice data.

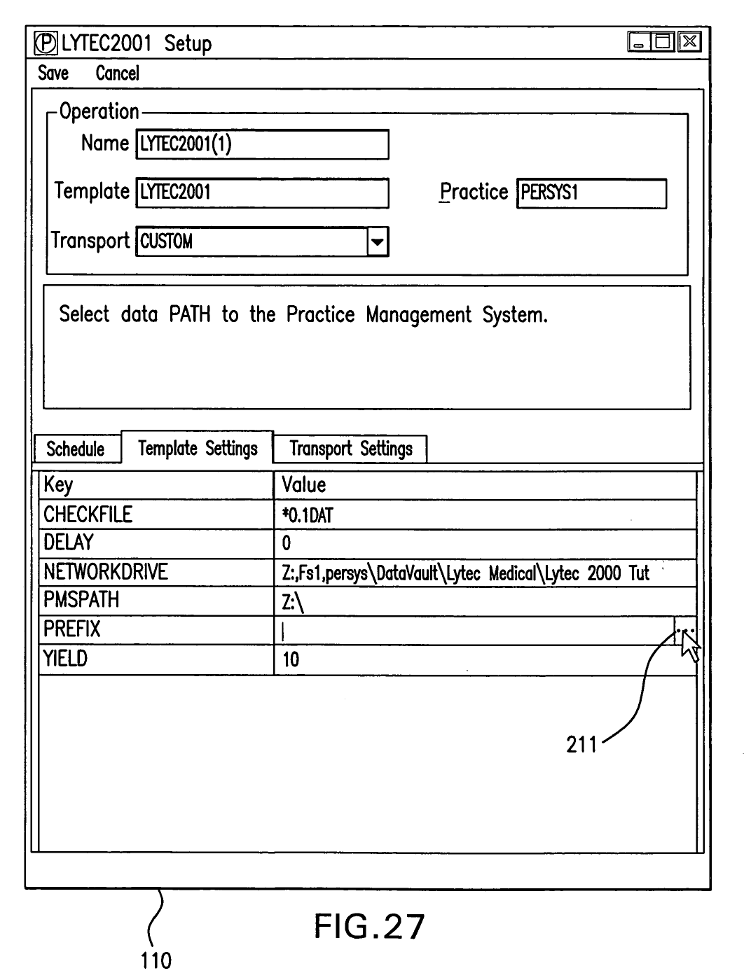

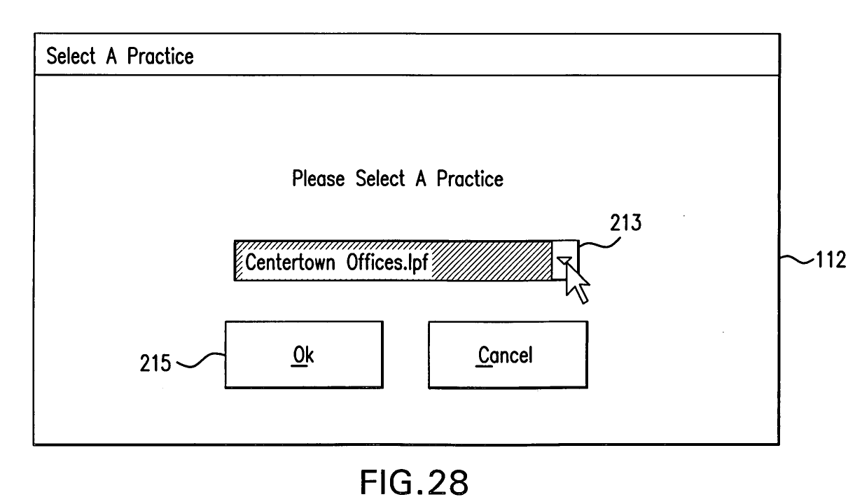

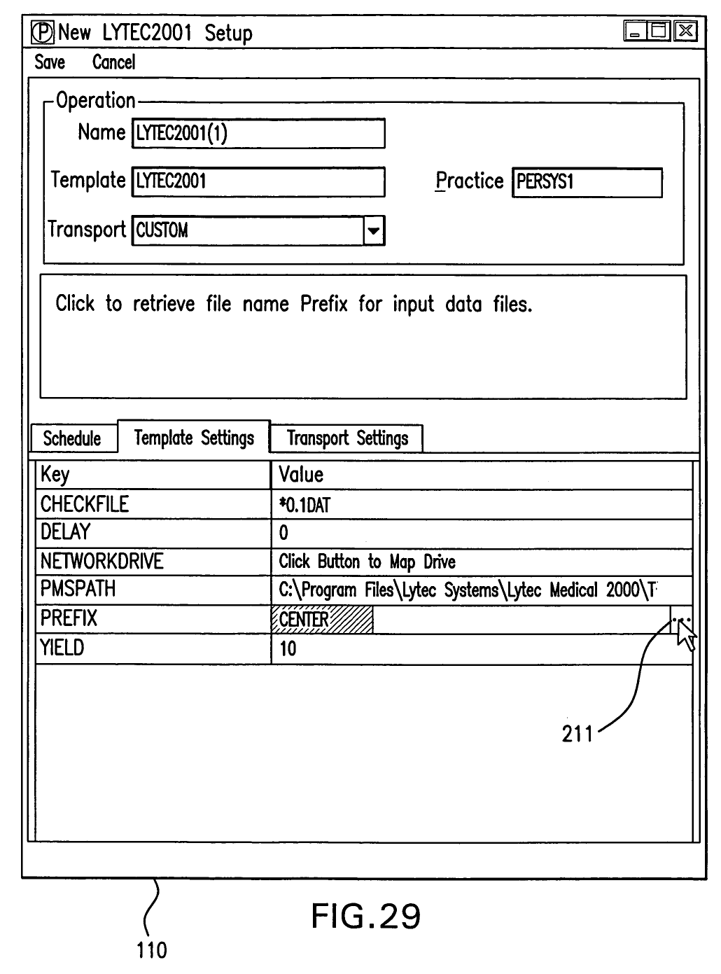

The user double clicks on button 211 to set the prefix in FIG. 27. If the selection (e.g., PMSPATH) points to a mapped drive, a secondary window 112, as illustrated in FIG. 28, opens. The user selects the data set that the PMI is to access using the drop down button 213 and clicks the “OK” button 215. However, if the drive has been previously mapped and the user locates the path using drop down button 201, the prefix is filled in when the button 211 is clicked, as illustrated in FIG. 29.

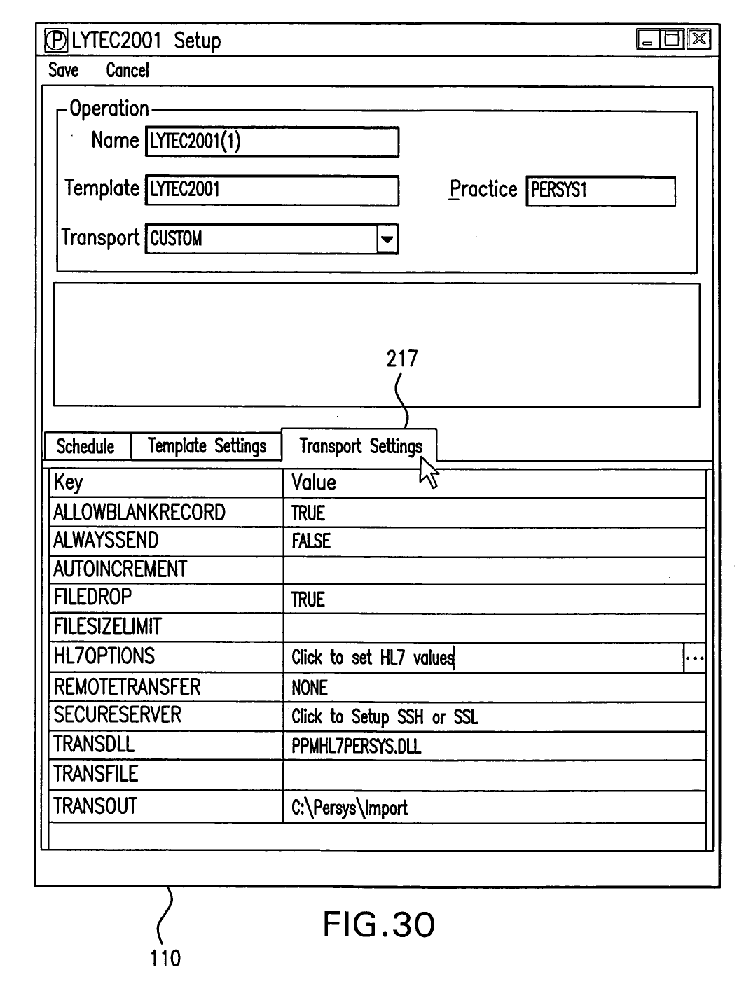

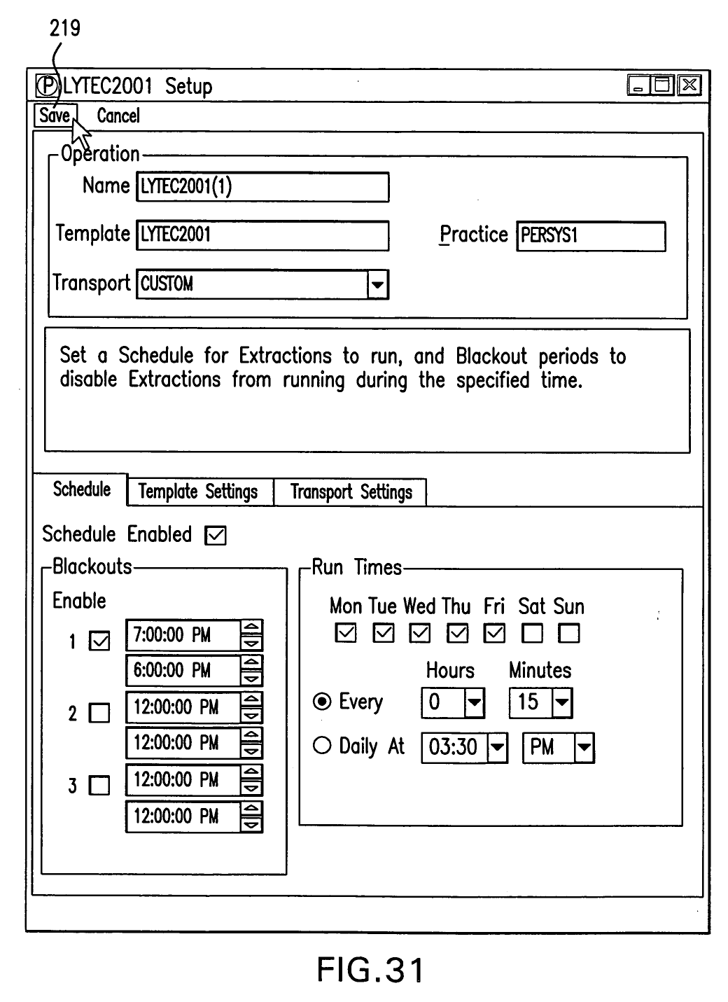

Next, the user enters “Transport Settings” by selecting the tab 217 in FIG. 30. Many of the fields have been hard-coded into the PMI software using specifications provided by the vendor. However, some fields can be entered during installation and setup of the PMI software, and are provided to the user by the vendor (e.g., Appendix D). The user verifies the schedule and template settings, and clicks the “Save” button 219 (FIG. 31) to complete the setup for the PMI.

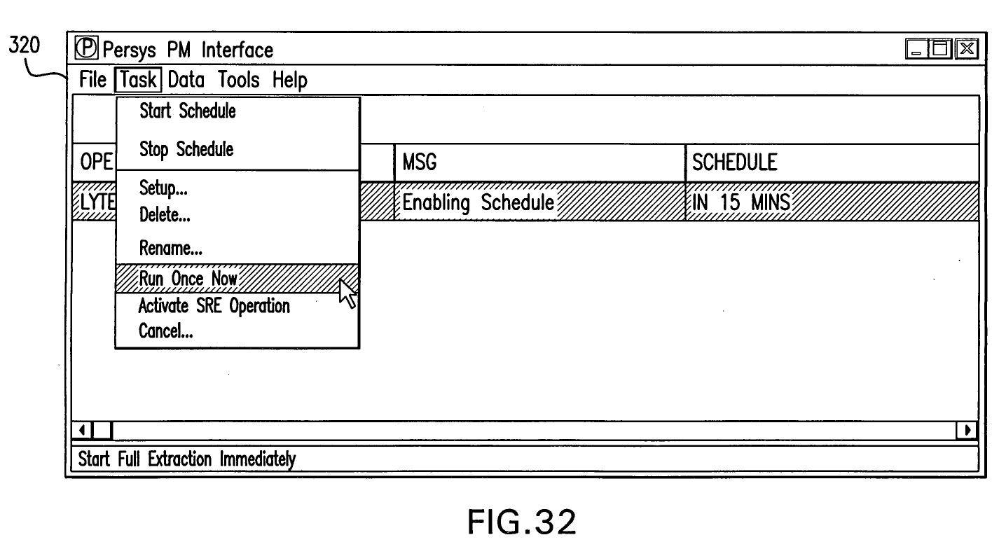

To verify that the drive is set up correctly and the data can be read, the user selects “Task” on the toolbar 320 (FIG. 32), and the “Run Once Now” option. Accordingly, the extraction completes and the scheduler starts, e.q., fifteen minutes after the last extraction finishes. If problems exist with the initial extraction, the user reviews the settings as set forth above.

2. Setting Up SRE (Single Record Extraction) with a Network Connection

Setting up a SRE template via a network connection is very similar to setting up a FRE template, as discussed in detail above. The user highlights the desired template, e.g., Lytec SRE and selects “Template” and then “License.”

3. Setting Up SRE with a Serial Connection

A serial connection is for a configuration that is terminal based (e.g., older PMS servers). In this scenario, the PMI does not connect over a network, but via a terminal login to a UNIX computer. Serial connections are limited to SRE templates only. When setting up a template via a serial connection, Omni-Lite is not required to map the drive. To complete the setup, the path to the practice data on the UNIX server must be known. Appendix C provides instructions on how to find the path.

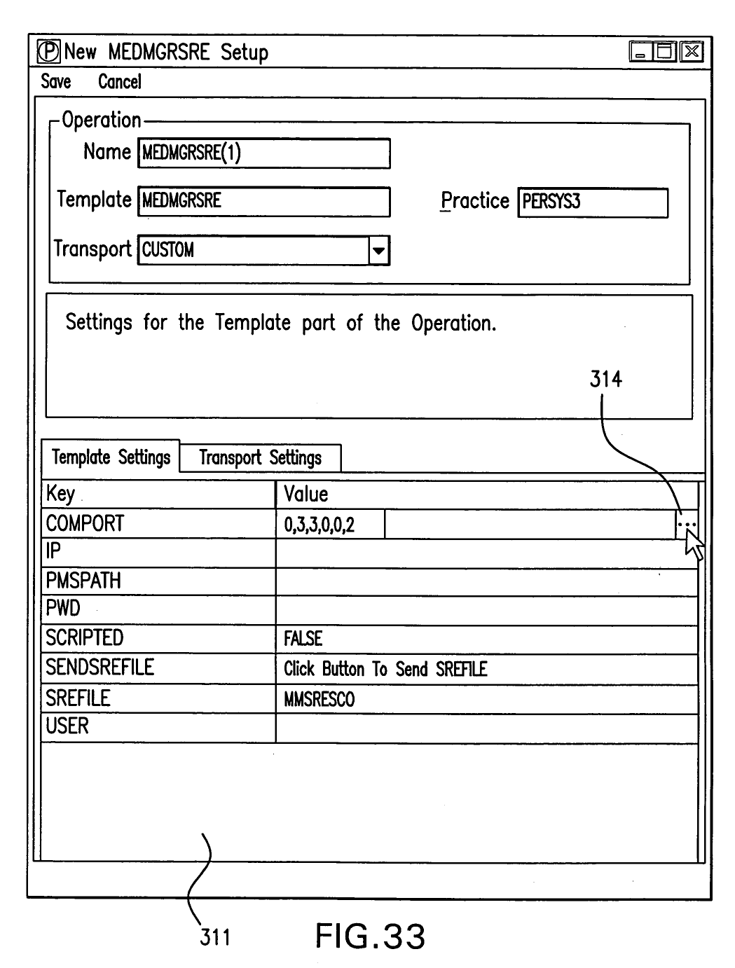

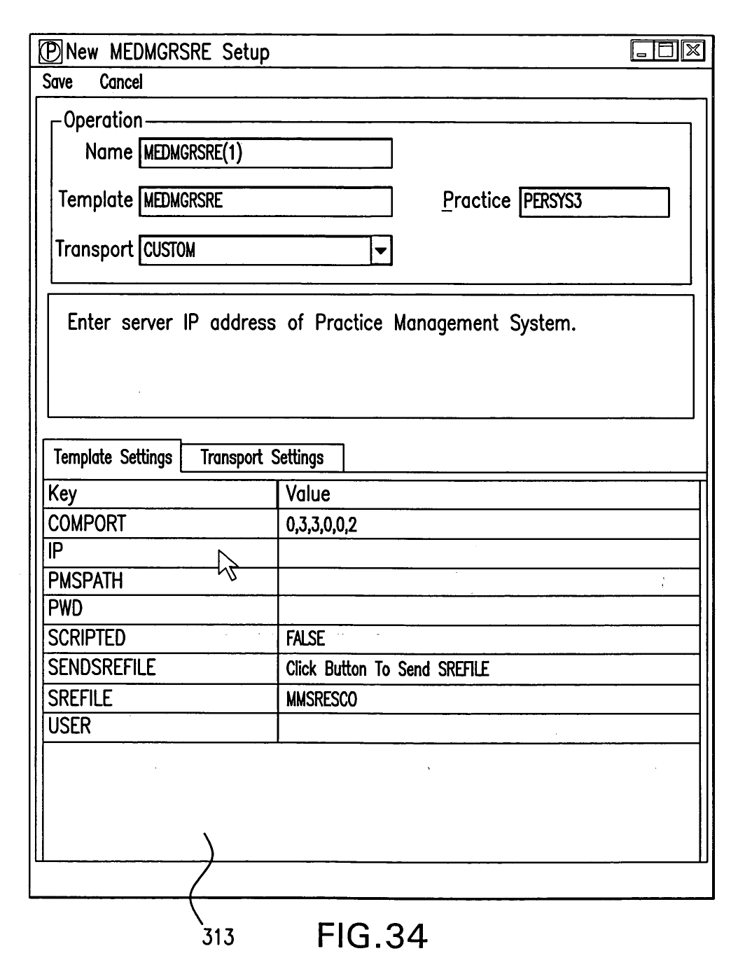

The initial steps in setting up a serial template are very similar to the templates described above. For example, the template is licensed, and the user enters data in the setup window. The setup window for Medical Manager SRE, however, looks different compared to other templates. As illustrated in FIG. 33, the user verifies the “Comfort” number (e.g., default setting) in window 311. If the “Comfort” number is incorrect, the user corrects it by clicking the drop down button 314 and selecting the correct information. As illustrated in FIG. 34, an entry is not entered in the “IP” field 313 for a serial connection. An entry is only entered for network SRE connections.

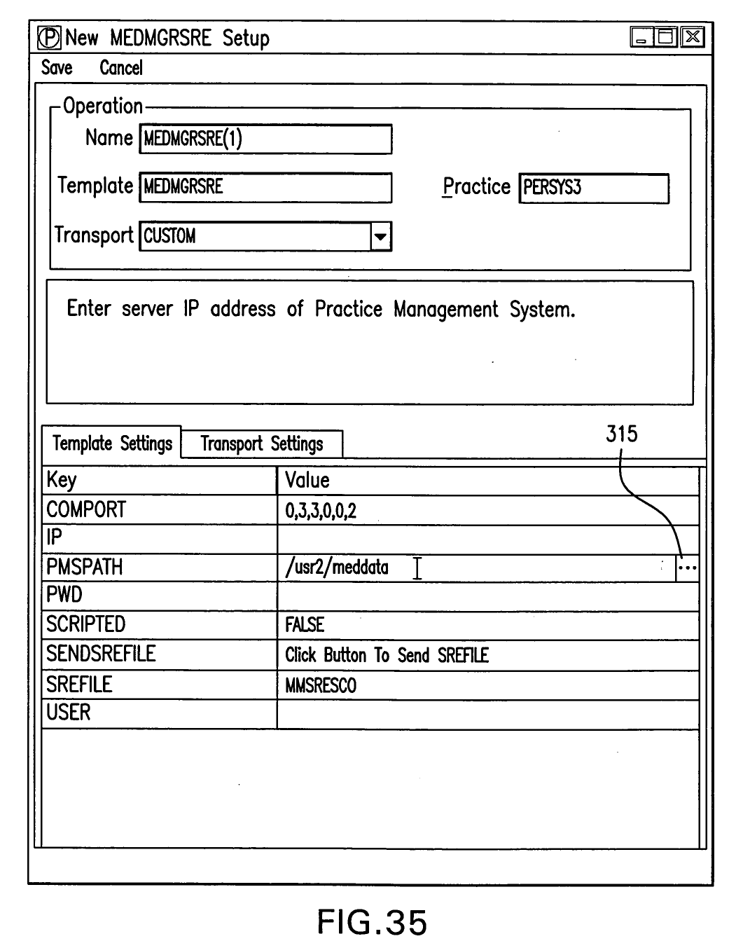

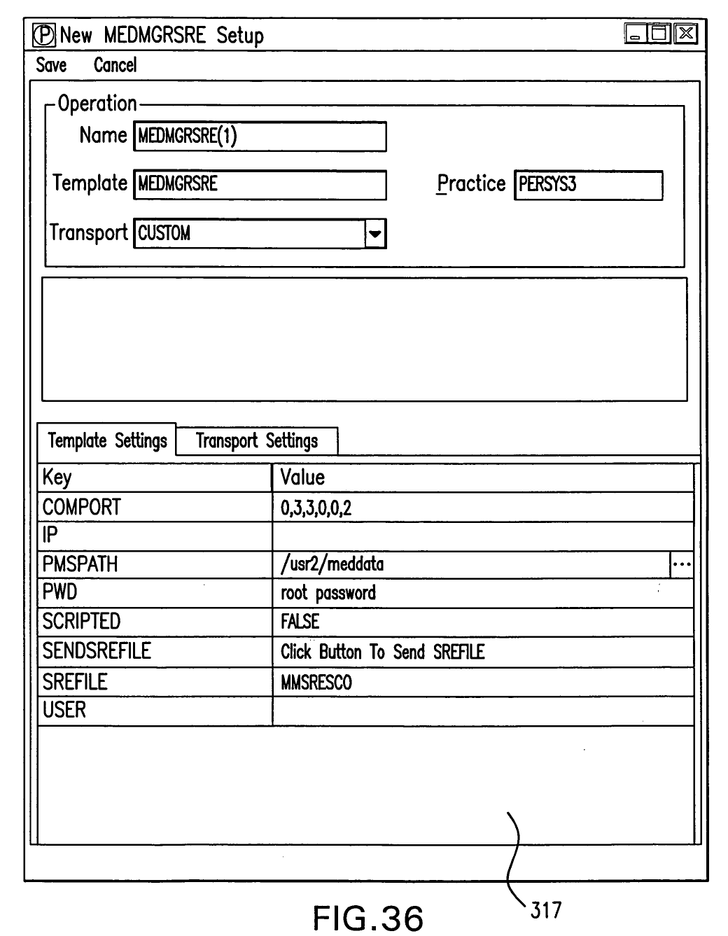

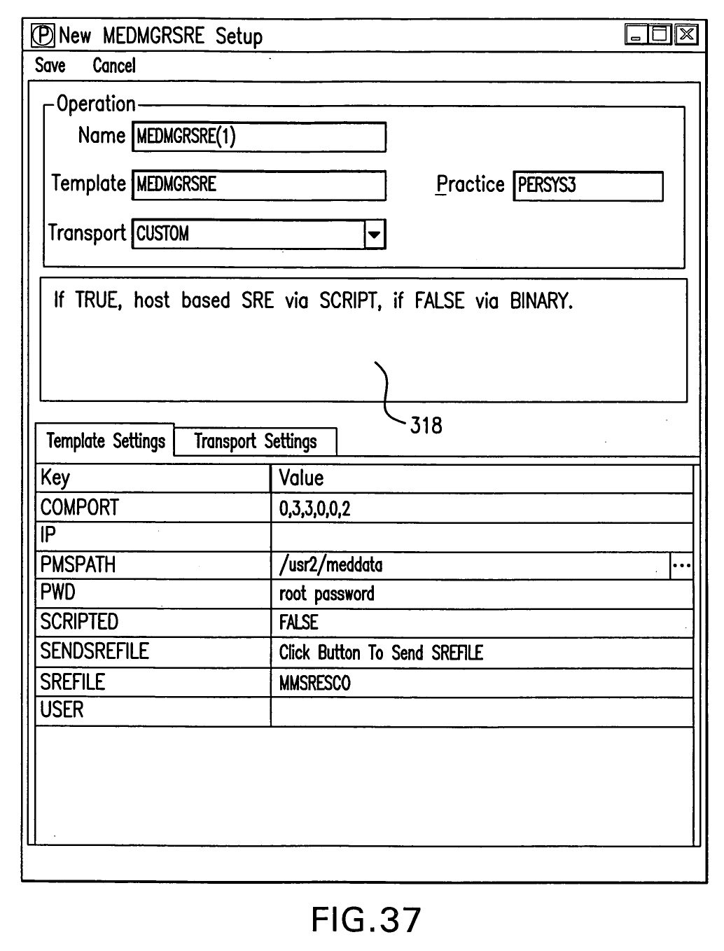

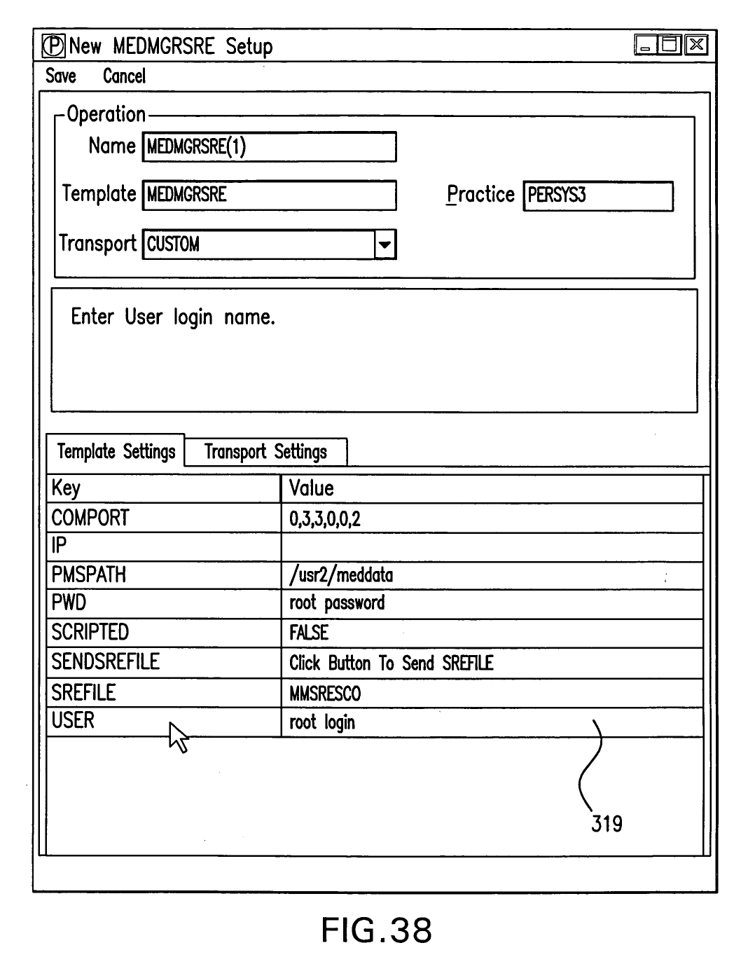

Next, the user selects a data path by selecting the drop down button 315 (FIG. 35). For example, the data path (/usr2/meddata) has been selected in FIG. 35. Appendix C provides additional information on the data path. The user then enters a root password in the “PWD” field 317 of FIG. 36. Later in the setup process, the root password is changed to a non-root login. This option is always set to false (default), as illustrated in window 318 (FIG. 37), and provides a failover mechanism for SRE in case of older operating systems. The user enters a root login name in the “User” field 319 (FIG. 38). Similarly, later in the setup process, the root login name is changed to a non-root user.

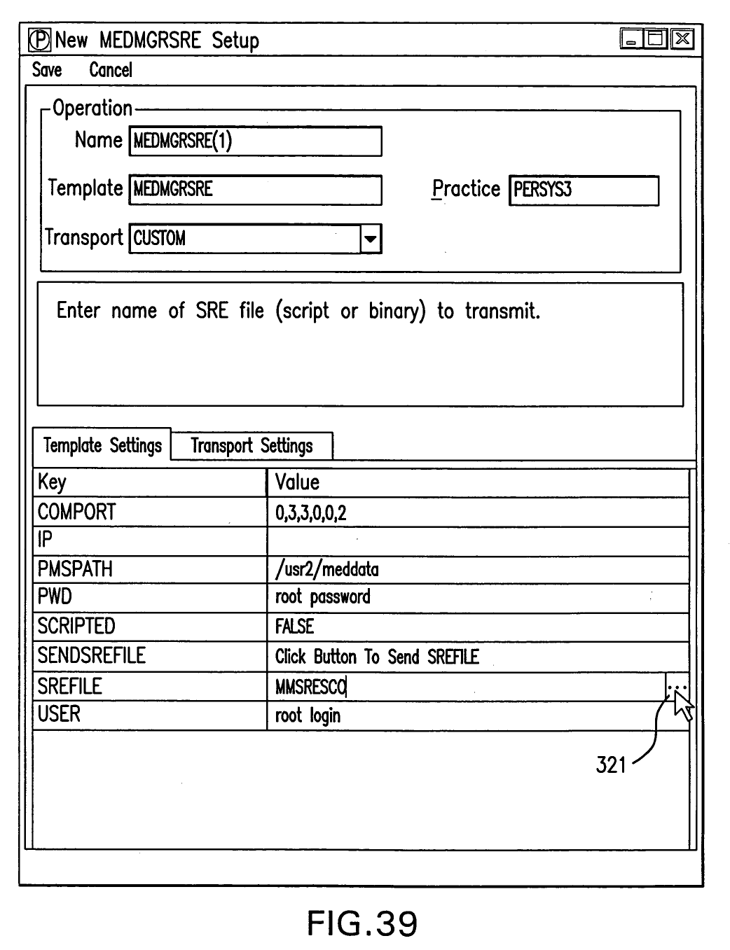

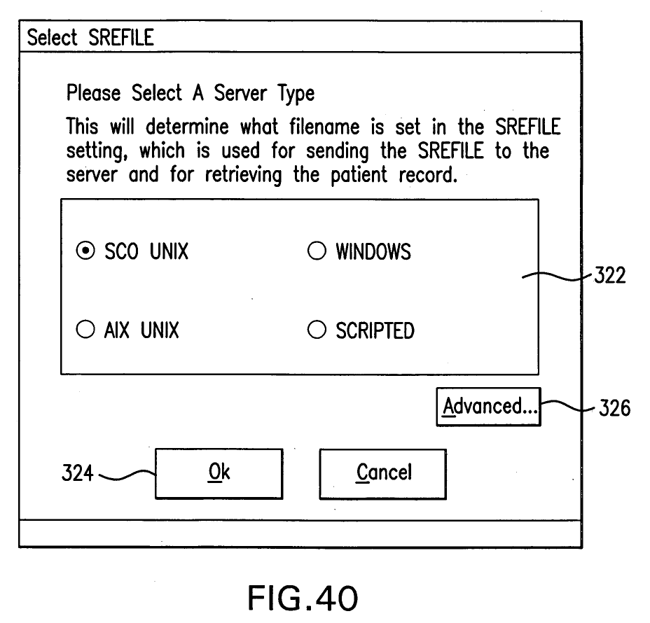

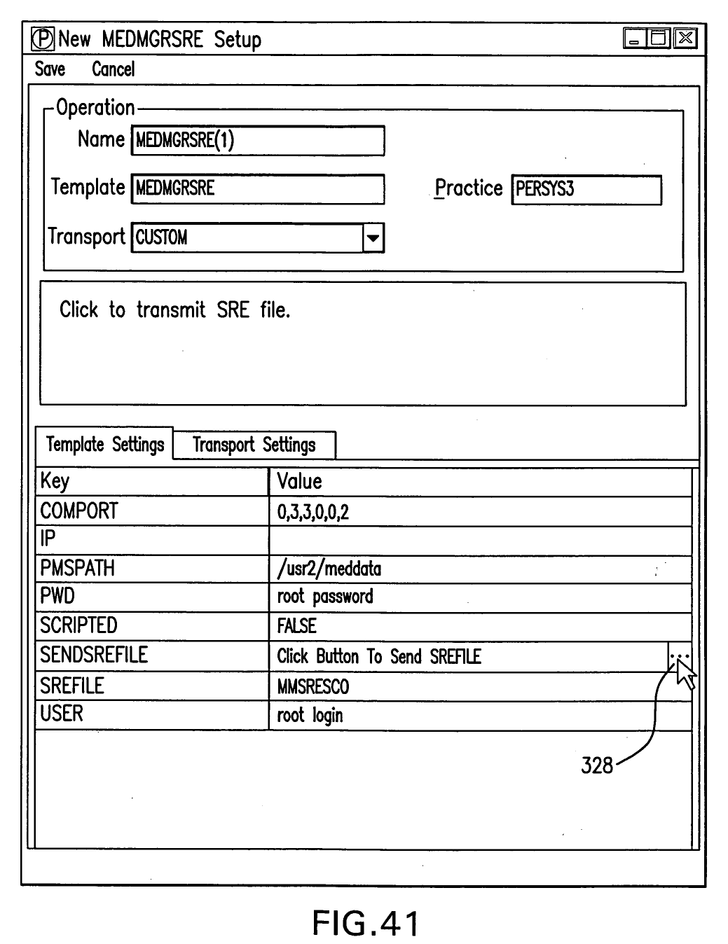

Referring to FIG. 39, the user clicks the button 321 to select the server that PMI SRE runs against. The operating system of the PMS server is selected in FIG. 40. For example, the appropriate radio button: SCO UNIX, AIX UNIX, Windows or Scripted (selected if using a version of UNIX other than SCO or AIX) is selected in window 322. The “Advanced” button 326 is used only if instructed by the vendor. The user clicks the “OK” button 324 (FIG. 40), and double clicks on the button 328 to send the SRE file (FIG. 41).

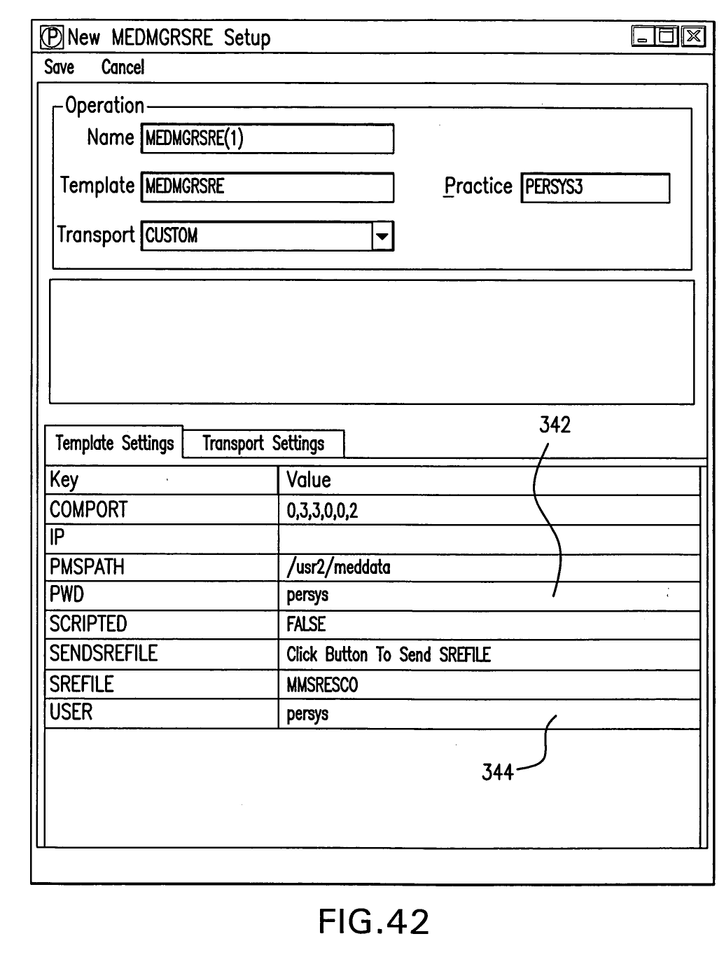

A portion of the SRE configuration requires a one time transfer of a small script to the UNIX PMS server. The script is a client-user or service provider application that is part of the search request. The installation of the script usually requires administrative privileges, which on UNIX requires the user to have temporary root login information. Once the user has been set up, the “PWD” field 342 and the “User” field 344 is changed accordingly (FIG. 42).

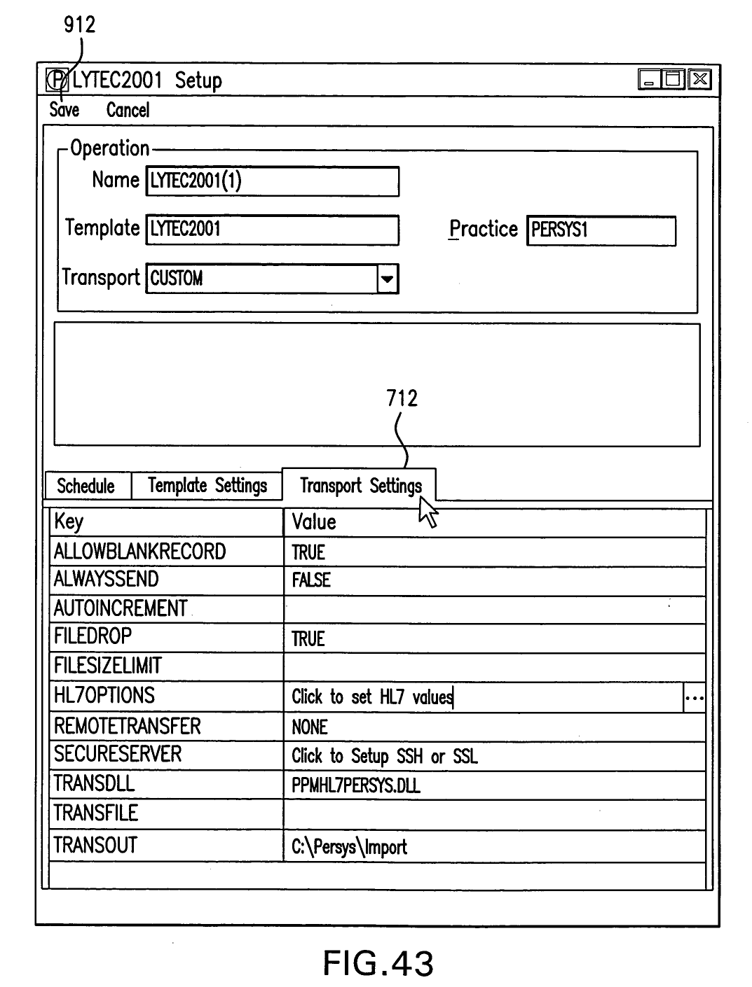

Next, the user enters “Transport Settings” by selecting the tab 712 in FIG. 43. Many of the fields have been hard-coded into the PMI software using specifications provided by the vendor. However, some fields can be entered during installation and setup of the PMI software, and are provided to the user by the vendor. The user verifies the entries and clicks the “Save” button 912.

D. Omni-Lite

Omni-Lite is an NFS (Network File System) Client that “talks” to an NFS Server on the network by using a protocol standard. Omni-Lite, or a similar application, is necessary when the PMI client-user device is connected to a UNIX PMS server.

1. Licensing Omni-Lite

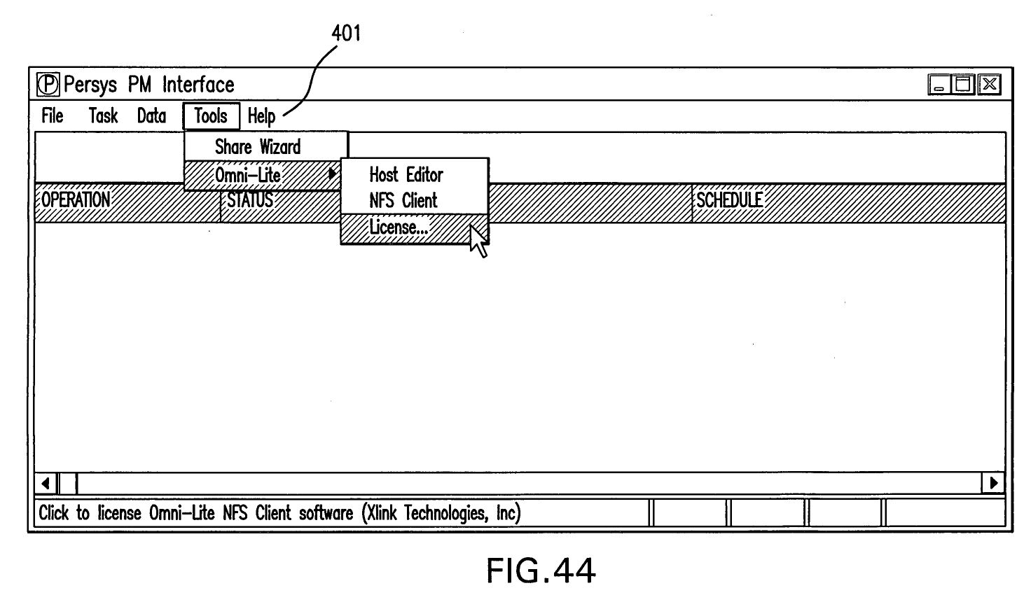

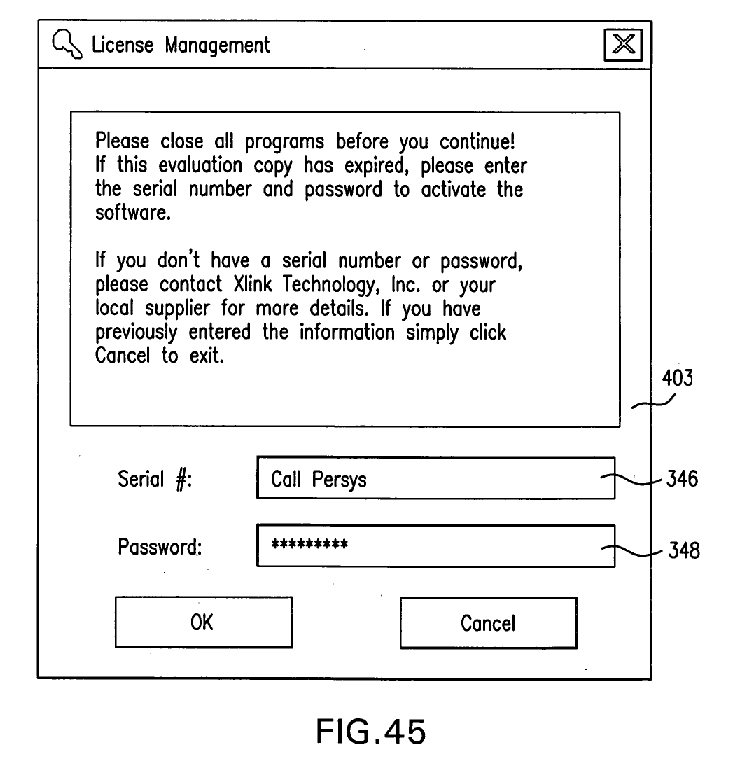

The user clicks “Tools” on the toolbar 401 of FIG. 44, and selects “Omni-Lite” and then “License” to open the licensing window for Omni-Lite. The user obtains a serial number and password from the vendor to activate and license the Omni-Lite software. The serial number and password are entered into fields 346 and 348, respectively, in window 403 (FIG. 45).

2. Omni-Lite Configuration

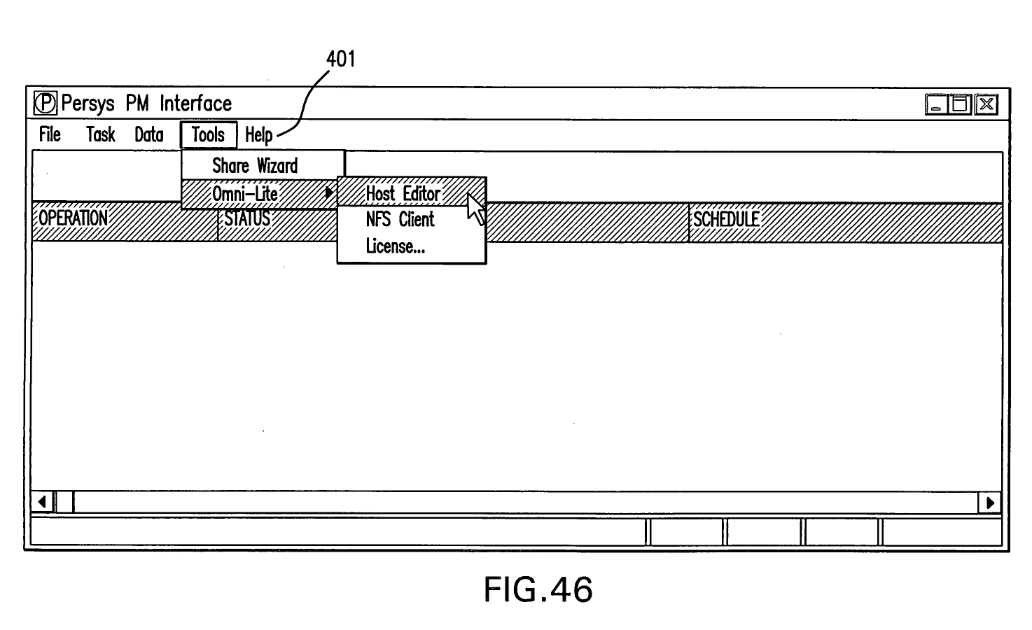

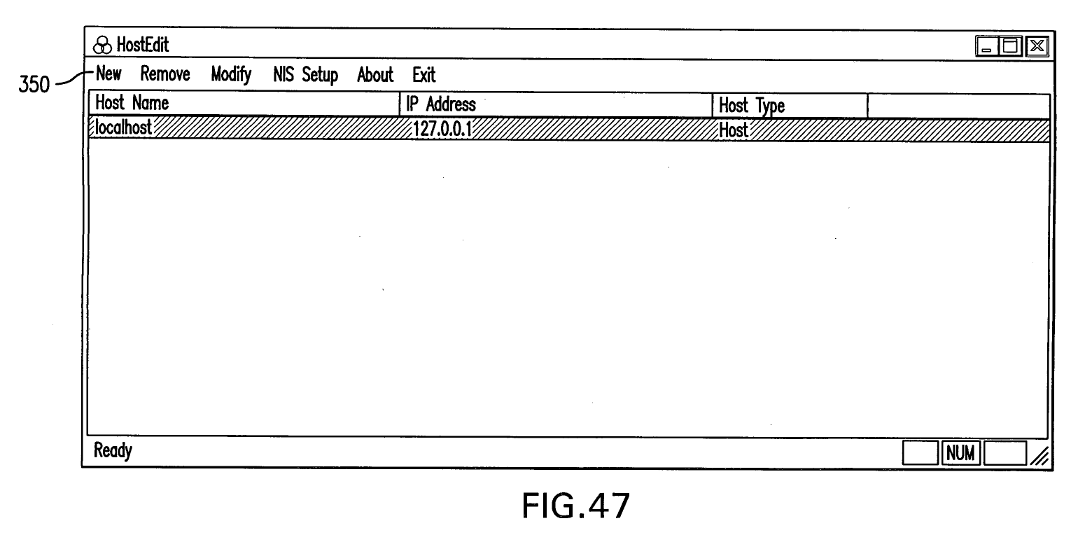

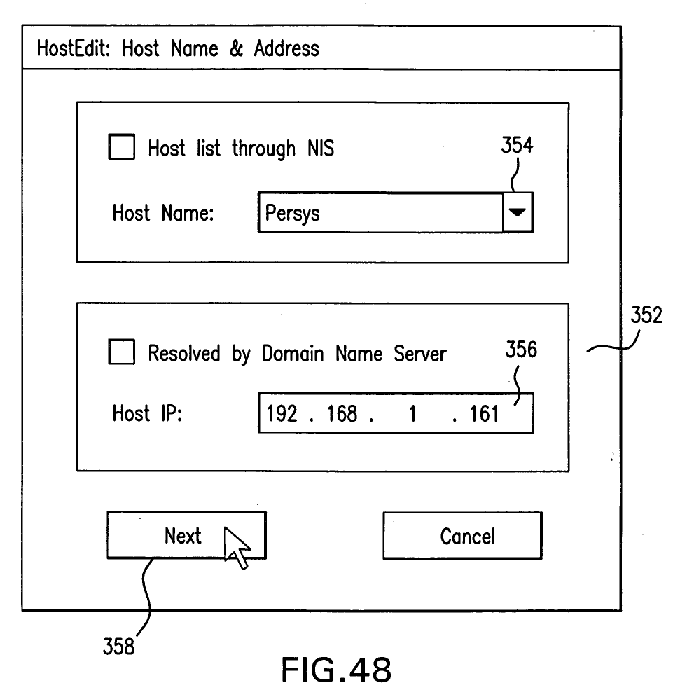

The user configures the NFS by defining the NFS server that contains the PMS data. The Omni-Lite Host Editor is opened by clicking “Tools” on the toolbar 401, and selecting “Omni-Lite” and then “Host Editor” in FIG. 46. The user clicks the “New” button 350 (FIG. 47) to define the NFS server, and a window 352 is displayed, as illustrated in FIG. 48.

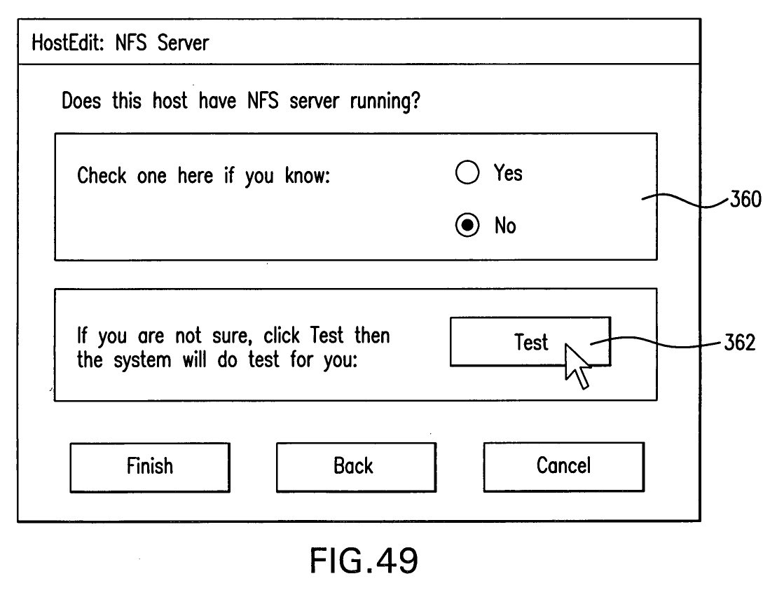

Referring to FIG. 48, the user selects the “Host Name” of the server using drop down box 354, and enters the server “IP Address” in field 356. Once both fields have been entered, the user clicks the “Next” button 358. To verify that the NFS is working on the server, the user clicks the radio button “No” in window 360 (FIG. 49), and then clicks the “Test” button 362.

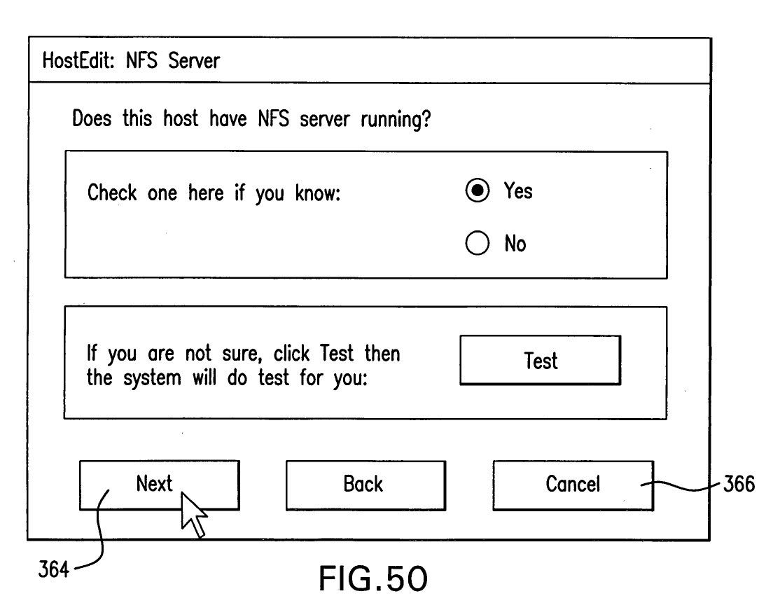

The radio button “Yes” in window 360 is automatically enabled when the “Test” button 362 is selected in FIG. 50. If the radio button “Yes” is not automatically enabled, the NFS Server is not responding or the network is configured improperly. The user clicks the “Next” button 364 to proceed or the “Cancel” button 366 to exit.

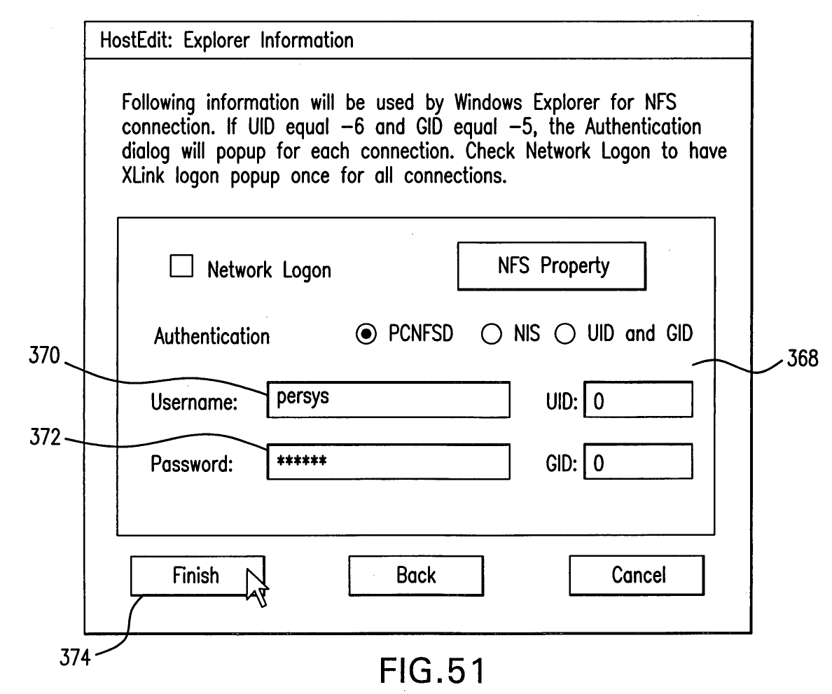

If a new user account is created in the “Configure Privileges section” (not shown), the user enters the vendor's username and password in the “Username” field 370 and the “Password” field 372, respectively, in window 368 of FIG. 51. If a root account is used, the user enters the “root” and the root password in fields 370 and 372, respectively. The user then verifies whether or not the “Authentication” field is set to “PCNFSD” by selecting the appropriate radio button, and clicks the “Finish” button 374 upon completion.

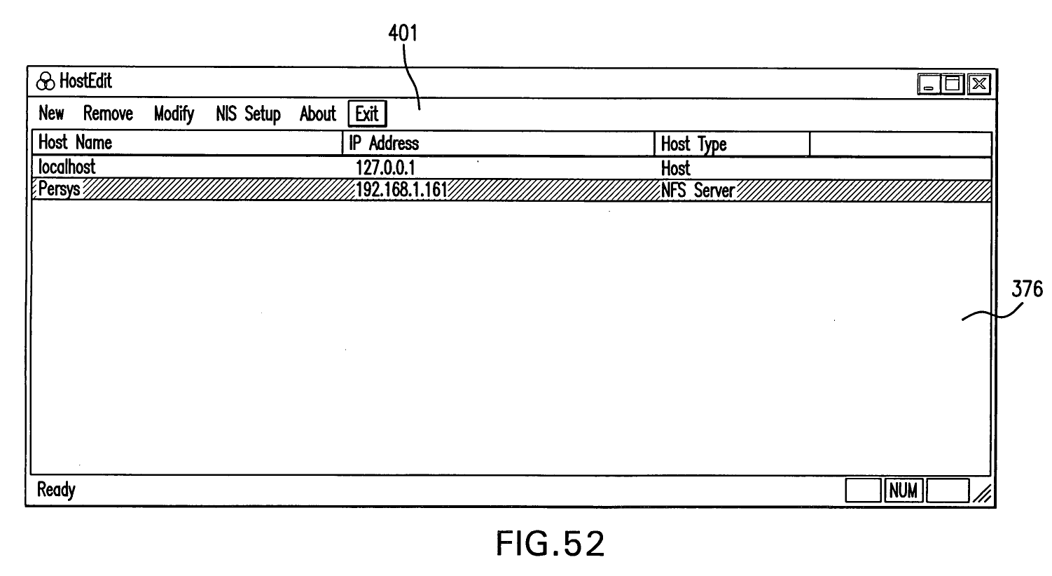

The NFS Server will be listed in the “HostEdit” box 376 of FIG. 52. If it does not appear, the Host Editor Section is restarted, and when the correct server is listed, the user exits the Host Editor by clicking “Exit” from the toolbar 401.

E. Uninstalling PMI

Uninstalling the PMI is very simple. The PMI can either be removed through Add/Remove programs in Windows or by using the computer product.

1. Add-Remove Programs

The PMI can be removed by going to the Add/Remove programs window, and selecting the PMI program and clicking the “Remove” button (not shown). Similarly, if Omni-Lite is installed, it can also be removed using the same process.

2. PMI Installation Computer Product

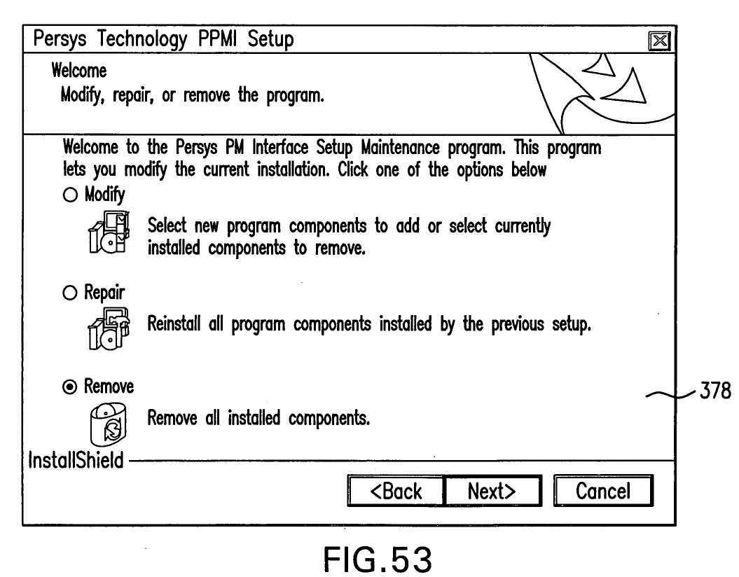

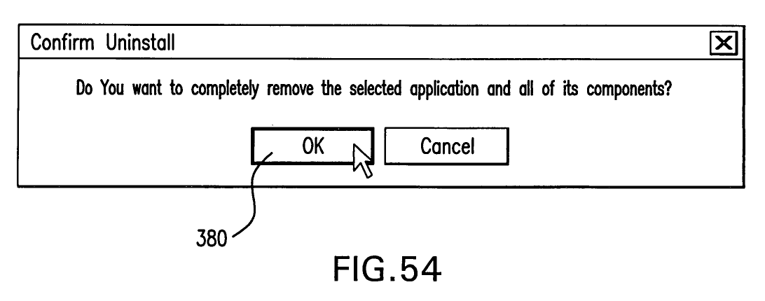

The PMI can also be removed by reinserting the computer product, and selecting the “Remove” button (not shown) from the setup window. A window 378 (FIG. 53) is displayed, and the user elects to have the PMI removed by selecting the “OK” button 380 in FIG. 54.

V. Conclusion

The information retrieval system, method and computer product of the present invention is an automated background process that requires no integration programming, manual mapping, or user intervention. The system, method and product of the present invention do not require screen scraping or report generation, and can be implemented on Windows and UNIX systems. Data output is normalized and transferred directly to a client-user using a standard implementation process.

While a preferred embodiment of the present invention has been described above, it should be understood that it has been presented by way of example only, and not limitation. Thus, the breadth and scope of the present invention should not be limited by the above described exemplary embodiment.

Obviously, numerous modifications and variations of the present invention are possible in light of the above teachings. It is therefore to be understood that the invention may be practiced otherwise than as specifically described herein.

### Appendix A

Network/Serial Troubleshooter

Network Troubleshooter

The Network Troubleshooter is designed to utilize basic networking to restore network connectivity between the PPMI Host PC and the PMS Server. Commands to be issued are identify by bold font.

For local network, verify that cables have been connected to Ethernet ports.
Verify activity lights on the Ethernet card, and/or the hub/switch, if any.

Ping the Practice Management Server by IP Address:
From the Start Menu, click Run.
Type in the word command, and press Open.
In the Command Prompt window type:
   ping x.x.x.x
   (Where x.x.x.x is the IP Address of the Practice Management Server).

If the network is setup properly, a response similar to the following should appear:

[image]

If the Reply lines appear, then the PPMI Host PC is able to transmit data to the PMS Server. This verifies that the network is working properly.

If the Reply lines do not appear, then the ping test to the Practice Management Server failed. This is often an effect of improperly configured TCP/IP properties.

To Troubleshoot:

From the Network Control Panel, verify that the PPMI Host PC is on the same subnet as the PMS Server.

From the Network Control Panel, Verify that the PPMI Host PC is not using an IP Address that is already in use on the network.

If either IP Address or netmask is incorrect, change those values and restart the system if necessary.

### Appendix A

Restart the ping test. If the ping test still fails, network cabling or hardware may be faulty.

Serial Troubleshooter

Com Ports

Serial ports are identified as COM ports on your computer. Each COM port is identified by a corresponding number, so the first COM port is COM1, the second is COM2 and so on. When connected to a server by a serial connection, you need to first identify which COM port the server is connected to. Once you have identified the COM port, you will need to verify its settings so that they match the settings of the template. To access the settings for the COM port, open the device manager, double-click on ports, and then double-click on the COM port that is connected to the PMS server. This will open the Properties page for the COM port. Click on the Port Settings tab, and check against the settings for the Template. The same should be done if a Lab system is connected to a second COM port. Verify the settings for the COM port connected to the lab system against the corresponding Listener operation.

[image]

HyperTerminal Testing

To start HyperTerminal click Start→Programs→Accessories→Communications→HyperTerminal. You will be prompted to enter a name for the session, type in SerialTest. The next prompt will ask what to connect to. Select the COM port you will be testing from the Connect Using drop down list. After selecting the correct COM port, a settings window will appear. Change the settings to equal those of the template or listener that you plan to use on this port. After clicking OK, you will be taken into the main console for HyperTerminal. Hitting the enter key should bring up a login prompt for the connected PC. If nothing happens after hitting enter, then the connection does not exist. First, verify that all physical connections exist (i.e. com ports, serial cables, hubs). If a physical connection exists, click the disconnect button, then the properties button. From the properties window click the Configure button. This will allow you to adjust the settings on the port. Each time you adjust a setting, click Ok, then click the Connect button from the HyperTerminal console window. If the connection still does not exist, repeat the process to adjust the settings, and attempt to connect. Continue until a connection is established, and you are able to login to the connected PC. Once you have established the connection, be sure to change the settings in the corresponding template or listener to match those that were required to establish the connection.

### Appendix B

UNIX/Windows File Sharing

This section describes methods for creating network file shares, in order for a Windows Network to see the UNIX PMS Server. This is essential in order for the Persys PM Interface™ to interact with your PMS.

What is File Sharing?

File Sharing is a service that enables users to access files from different computers on their network. Once File Sharing software is installed or configured, a user may ‘map’ a network drive from the computer, which allows for reading and/or writing files to the PC that is shared. This is similar to file and print sharing for Microsoft Windows.

Why is there a need for File Sharing software?

In the case of Practice Management Systems it is not always a Windows computer that will need to be mapped. Some Practice Management Systems are UNIX based, and standard Windows file and print sharing will not work with UNIX. If the PMS Server is Windows based, then there will be no need for additional File Sharing software. If the PMS Server is UNIX based, then additional File Sharing software will be required, since the Persys PM Interface™ requires a network file-share to do its work. The File Sharing options for UNIX based Practice Management Systems are identified and described below.

Which method do I use?

There are a few methods to create the connection:

SCO VisionFS

SCO VisionFS is a high performance, server-based file and print sharing solution. It installs purely on the server so all PCs on the network gain instant and transparent access to UNIX OS files and printers.

Samba

Samba is an Open Source/Free Software suite that provides seamless file and print services to SMB/CIFS clients. It is compiled to run on a UNIX type Operating system, with minimum setup.

Omni-Lite

Omni-Lite is a robust NFS network connectivity solution for integrating Windows 95/98/2000/NT/XP and UNIX workstations. It allows Windows 95/98/2000/NT/XP users to gain access to resources residing on any UNIX/NFS PCs, straight from the Windows desktop. NFS drives and printers can even be mounted automatically through NT Explorer or Network Neighborhood like any other Windows network resources.

NOTE: The default method to create the file-share is Omni-Lite

The method used depends upon the type of Server Operating System
If the type of Practice Management Server Operating System is known, see the table below. If the Server Operating System is listed, then cneck which software suite will support it. If it is not listed, alternative methods will need to be considered.

### Appendix B

Obtaining File Sharing Software

Although the Server Operating System may support some or all versions of the File Sharing methods listed, Persys recommends the Omni-Lite software suite to any other that has been listed. All software media is distributed on CD-ROM and Persys will handle the shipment of the CDs.

| | Supported? | | |
|---|---|---|---|
| Operating System Platforms | VisionFS | Samba | Omni Lite |
| SCO OpenServer 5.0.2, 5.0.4, | Yes | Yes | Yes |
| 5.0.6 | | | |
| SCO Unix < 5.0.0 | No | No | Yes |
| UnixWare 2.1.3+ | Yes | Yes | N/A |
| UnixWare 7+ | Yes | Yes | N/A |
| Sun Solaris < 2.51 (SPARC) | No | Yes | Yes |
| Sun Solaris 2.51+ (SPARC) | Yes | Yes | Yes |
| Compaq Tru64 4.0D+ | Yes | N/A | N/A |
| IBM AIX 4.2+ | Yes | Yes | Yes |
| SGI IRIX 5.3+ | Yes | N/A | Yes |
| HP-UX 10.01+ | Yes | Yes | Yes |
| HP-UX 11+ | Yes | Yes | Yes |
| Siemens Reliant UNIX 5.43+ | Yes | Yes | N/A |
| NetBSD | No | Yes | Yes |
| FreeBSD | No | Yes | Yes |
| Ultrix | No | N/A | N/A |
| Linux | Yes | Yes | Yes |

NFS—The ‘UNIX’ Protocol

Network File System (NFS) is a protocol designed to allow PCs to mount a disk partition on a remote PC as if it were on a local hard drive. This allows for fast, seamless sharing of files across a network. There are two pieces to NFS:

The NFS SERVER is the PC that makes file systems available to the network. It does so by either EXPORTING or SHARING them.

The NFS CLIENT is the PC that accesses file systems that have been made available. It does so by MOUNTING them.

SMB—The ‘Windows’ Protocol

SMB is the protocol by which PCs share files and printers and other information such as lists of available files. Operating systems that support this natively include Windows NT, OS/2, and Linux. Add-on packages that achieve the same thing are available for DOS, Windows, VMS, UNIX of all kinds, MVS, and more. Apple Macs and some Web Browsers can speak this protocol as well. Alternatives to SMB include Netware, NFS, AppleTalk, Banyan Vines, Decnet, etc.

### Appendix B

File Sharing with SAMBA

Samba is an Open Source/Free Software suite that provides seamless file and print services to SMB/CIFS clients. It is compiled to run on a UNIX type Operating system such as SCO Open Server/UNIX Ware, AIX, Sun Solaris, HP-UX, Linux and many more. Its concept is comparable to File Sharing on a Windows network; normally the case would be a Windows PC mapping a drive on a Windows PMS Server, here they are mapping a drive on a UNIX PMS Server. A user would not know the difference.

This how-to describes how to configure the Samba server and create a Samba share for access by other PCs on the network.

Installing Samba:

The first step to installing Samba is to identify the name and version of the Practice Management Server Operating System. Once this is known, select the appropriate Samba binaries. It is important to use the appropriate Samba binaries. Another set may yield different results concerning performance and effectiveness. Persys maintains a library of Samba binaries

While Persys maintains a Samba library, Persys does not support Samba. Contacting Persys for technical support will result in billable charges.

Samba by default is installed in /usr/local/samba. After installation, the next step is to configure the Samba Server.

Windows/Windows File Sharing

From the PMS Server, open Windows Explorer. To open Windows Explorer, go to the Start Menu, go to Programs→Accessories→Windows Explorer. Once Windows Explorer is opened, navigate to the PMS File Folder. Right-click on the PMS folder, then left-click on Properties (or Sharing and Security). Click on the Sharing tab. Move the radio button to Share this Folder. Click the Apply button and then the OK button. NOTE: This may not be needed as the PMS File Folder may already be shared or a folder above it may already be shared. Please check to see if the folder is already setup for sharing before completing the above steps.

### Appendix C

NFS Server Startup

This instruction set explains how to configure NFS on various UNIXes. NFS Configuration is defined as setting up the authentication daemon (PCNFSD), setting the NFS Server to start at boot time, adding the host which will access NFS, defining a read-only share, creating a user that will use the share and starting the NFS subsystem. Commands to be typed at the system prompt are bolded.

NOTE: Before starting these steps, you will need to be logged in as the root user

Write /etc/hosts—Add the IP address of the PPMI Host to a UNIX system file.
ALL BEGIN
   CMD echo “ip hostname”>>/etc/hosts

CONFIRM grep hostname /etc/hosts

| | Write /etc/hosts - Add the IP address of the PPMI Host to a UNIX system file. | | | |
|---|---|---|---|---|
| ALL BEGIN | | | | |
| CMD | echo “ip hostname” >> /etc/hosts | | | |
| CONFIRM | grep hostname /etc/hosts | | | |
| | Write/etc/exports - Add | Start NFS - | Add User - | Add Passwd - |
| | the path to the practice | command to start | create a user | assign a |
| | data to the NFS control file | the NFS subsystem | that will use the | password to |
| | | | NFS share | the new user |
| SCO | | | | |
| CMD | echo “/pathto/practicedata -ro” >> | /etc/nfs start | useradd persys | passwd persys |
| | /let/exports | | | |
| CONFIRM | cat /etc/exports | See Footnote B. | grep persys | see Footnote C. |
| | | | /etc/passwd | |
| AIX | | | | |
| CMD | echo “/pathto/practicedata -ro” >> | mknfs -B | mkuser persys | passwd persys |
| | /etc/exports | | | |
| CONFIRM | cat /etc/exports | See Footnote B. | grep persys | see Footnote C. |
| | | | /etc/passwd | |
| UnixWare | | | | |
| CMD | echo “/pathto/practicedata -ro” >> | sh /etc/init.d/nfs start | useradd persys | passwd persys |
| | /etc/dfs/dfstab | | | |
| CONFIRM | cat /etc/dfs/dfstab | See Footnote B. | grep persys | see Footnote C. |
| | | | /etc/passwd | |
| HP-UX | | | | |
| CMD | echo “/pathto/practicedata -ro” >> | See Footnote A. | useradd persys | passwd persys |
| | /etc/exports | | | |
| CONFIRM | cat /etc/exports | See Footnote B. | grep persys | see Footnote C. |
| | | | /etc/passwd | |
| Sun Solaris | | | | |
| CMD | echo “share -F nfs -o ro | /etc/init.d/nfs.server start | useradd persys | passwd persys |
| | /pathto/practicedata” >> | | | |
| | /etc/dfs/dfstab | | | |
| CONFIRM | cat /etc/dfs/dfstab | See Footnote B. | grep persys | see Footnote C. |
| | | | /etc/passwd | |

| | Reread/etc/exports - In case NFS was already running, reread the control file and |
|---|---|
| | add any new paths to the running server |
| ALL FINISH | |
| CMD | exportfs -a |
| CONFIRM | exportfs |

FOOTNOTES:

| | |
|---|---|
| A | 1. In the /etc/rc.config.d/nfsconf file, use a text editor to set the PCNFS_SERVER flag to 1, as follows: |
| | PCNFS_SERVER = 1 |
| | 2. In the /etc/rc.config.d/nfsconf file, make sure the NFS_SERVER and START_MOUNTD variables are |
| | set to 1, as follows: |
| | NFS_SERVER = 1 |
| | START_MOUNTD = 1 |
| | 3. If rpc.mountd is configured in/etc/inetd.conf on your system. set the START_MOUNTD flag to 0. |
| | Mounts will fail if rpc.mountd is enabled through both /etc/inetd.conf and /etc/rc.config.d/nfsconf. |
| | grep “rpc.mountd” /etc/inetd.conf |
| | If a line appears that does not begin with a #, then set the START_MOUNTD flag to 0. |
| | Otherwise, set this flag to 1. |
| | sbin/init.d/nfs.server start |
| B | At the command line type: rpcinfo -p localhost\|more This will confirm that the 3 necessary NFS programs |
| | are running. Looking at the services column, these words should appear: mountd, pcnfsd, nfsd. The root of |
| | the word is important here. The output may display multiple instances of each word, this is acceptable. |
| C | After completing the NFS Matrix, test the login and password account. Log-out and log back in as the new |
| | user. When prompted for the new password, simply re-enter the original password. |

### Appendix D

Add User Account

The following steps should be used for adding a user account after sending the SENDSREFILE script during the Medical Manager SRE installation process.

These steps will need to be executed as the ‘root’ user.

For SCO Unix

useradd -d /usr/persys persys
   What this command does: Creates the user
passwd persys
   What this command does: Starts passwd program to assign password to newly created user.
mkdir /usr/persys
   What this command does: Creates a home directory for the user to login to.
echo “#!/bin/sh\nPS1=\”$ \“\nexport PS1”> /usr/persys/.profile
   What this command does: Sets the command prompt when the user logs in to a ‘$’.
chown -R /usr/persys
   What this command does: Changes ownership of the home directory and files below it to the persys user.
      For AIX Unix
mkuser -a “home=/usr/persys” persys
   What this command does: Creates the user and home directory for the user.
passwd persys
   What this command does: Starts passwd program to assign password to newly created user.
echo “\nPS1=\”$ \“\nexport PS1” >> /usr/persys/.profile
   What this command does: Sets the command prompt when the user logs in to a ‘$’.

1. A method of conducting an electronic retrieval of information, comprising:
initiating a task;
communicating said task to at least one server device having a text data collection;
selecting a predetermined template from a plurality of templates which corresponds to said text data collection at a server device, said plurality of templates being associated with dissimilar text data collections;
identifying information in said text data collection at the server device;
extracting said information from said text data collection; and
transmitting the retrieved information to a client-user device.

2. The method of claim 1, wherein the selecting step comprises entering a predetermined identification code in the template.

3. The method of claim 2, wherein said identification code is a plurality of alphanumeric characters.

4. The method of claim 1, wherein said template allows for the transmitted information to be formatted, normalized and readable at said client-user device.

5. The method of claim 1, wherein access to said text data collection is read-only.

6. The method of claim 1, wherein said task is a query response.

7. The method of claim 1, wherein said task is user defined.

8. A system for identifying and extracting information from dissimilar text data collections, comprising:
listener/transport interface for communicating with a client-user device;
template interface for communicating with at least one server device having a database; and
engine interface for initiating tasks via said listener/transport interface, and communicating said tasks to said at least one server device via said template interface,
wherein information is identified in and extracted from said database of said server device, and transmitted to said client-user device.

9. The system of claim 8, wherein said template interface allows for the extracted information to be formatted, normalized and readable at said client-user device.

10. The system of claim 8, wherein said listener/transport interface and said template interface are interchangeable.

11. The system of claim 8, wherein said client-user device communicates with said server device using a PC/ITP connection.

12. The system of claim 8, wherein said client-user device and said server device are serially connected.

13. The system of claim 8, wherein access to said database of said server device is read-only.

14. The system of claim 8, wherein said task is a query response.

15. The system of claim 8, wherein said task is user defined.

16. A computer program embodied on a computer readable medium for a method of conducting an electronic retrieval of information as defined in claim 1.
